(19) United States
(12) Patent Application Publication
(10) Pub. No.: US 2015/0169356 A1
(43) Pub. Date: Jun. 18, 2015

(54) TRANSACTION PROCESSING SYSTEM

(71) Applicant: NEC Corporation, Tokyo (JP)

(72) Inventor: Hiroko NAGASHIMA, Tokyo (JP)

(73) Assignee: NEC Corporation

(21) Appl. No.: 14/554,349

(22) Filed: Nov. 26, 2014

(30) Foreign Application Priority Data
Dec. 17, 2013 (JP) 2013-259907

(51) Int. Cl. G06F 9/46; H04L 29/08; G06F 17/30; H04L 29/06

(52) U.S. Cl. CPC G06F 9/466; H04L 67/42; H04L 67/1097; G06F 17/30168

(57) ABSTRACT

A transaction processing system, which controls execution of transactions based on optimistic exclusion, includes a server device, a data storage device, and a client device. The server device determines whether or not a transaction, received from the client device, belongs to a priority class, and sets the value of a flag of the same set as the data to be used by a transaction determined to belong to the priority class, to a value which restricts update by a transaction not belonging to the priority class. Then, the server device controls execution of the transaction based on optimistic exclusion.

### INCORPORATION BY REFERENCE

The present application is based upon and claims the benefit of priority from Japanese patent application No. 2013-259907, filed on Dec. 17, 2013, the disclosure of which is incorporated herein in its entirety by reference.

### TECHNICAL FIELD

The present invention relates to a transaction processing system, a transaction processing method, a server device, a transaction processing method in a server device, and a program.

### BACKGROUND ART

A transaction processing system performs a plurality of transactions in parallel while ensuring data consistency, in order to improve data processing performance. As such, a transaction processing system uses an exclusive control technique. An exclusive control technique includes pessimistic exclusion and optimistic exclusion.

Pessimistic exclusion excludes (locks), in advance, entire data to be referred to or updated in transaction before executing the transaction to thereby secure data consistency. On the other hand, optimistic exclusion does not exclude (lock) data to be referred to or updated in transaction in advance. Instead, in the optimistic exclusion, whether or not data consistency is secured is checked at the end of the execution of the transaction, and if consistency is secured, the transaction is committed, while if not, a commit failed. In the pessimistic exclusion, as another transaction using the same data cannot be executed until a transaction which acquired exclusion ends, pessimistic exclusion lacks scalability. As such, in a transaction processing system which places emphasis on scalability, optimistic exclusion is used (for example, see JP 2013-45356 A (Patent Document 1).

Meanwhile, in a transaction processing system, processing a particular transaction in preference to another transaction has been proposed as first related art relating to the present invention (for example, see Patent Document 2). More specifically, in the first related art, each time data conflict occurs, the possessory right of the data is adjusted between the transactions, and the possessory right of the data is changed to a transaction which should have the highest priority in the course of business, whereby a particular transaction is processed in preference to other transactions.

Patent Document 1: JP 2013-45356 A

Patent Document 2: JP 6-332780 A

However, in the first related art in which the possessory right of the data is adjusted to thereby give a higher priority to a particular transaction than other transactions, as communications between transactions are required for adjusting the possessory right, it is difficult to secure scalability. As such, in the case of applying the first related art to a transaction processing system based on optimistic exclusion, the scalability deteriorates.

### SUMMARY

An exemplary object of the present invention is to provide a transaction processing system which solves the problem described above, that is, a problem that in a transaction processing system in which execution of transactions is controlled based on optimistic exclusion, it is difficult to process a particular transaction in preference to other transactions while securing scalability.

A transaction processing system, according to a first exemplary aspect of the present invention, includes a client device that transmits a transaction;

a data storage device that stores a set of data and a flag; and

a server device connected between the client device and the data storage device, wherein

the server device includes:
a priority determination unit that determines whether or not the transaction received from the client device belongs to a priority class;
a flag processing unit that sets a value of the flag of the same set as the data to be used in the transaction determined to belong to the priority class, among the data stored in the data storage device, to a value that restricts update by a transaction not belonging to the priority class; and
a transaction execution section that controls execution of the transaction received from the client device, based on optimistic exclusion.

A transaction processing method, according to a second exemplary aspect of the present invention, is a transaction processing method performed by a transaction processing system including a client device, a data storage device that stores a set of data and a flag, and a server device connected between the client device and the data storage device, the method including

by the client device, transmitting a transaction to the server device; and

by the server device, determining whether or not the transaction received from the client device belongs to a priority class, setting a value of the flag of the same set as the data to be used in the transaction determined to belong to the priority class, among the data stored in the data storage device, to a value that restricts update by a transaction not belonging to the priority class, and controlling execution of the transaction received from the client device, based on optimistic exclusion.

A server device, according to a third exemplary aspect of the present invention, is a server device connected between a client device that transmits a transaction and a data storage device that stores a set of data and a flag, the server device including

a priority determination unit that determines whether or not the transaction received from the client device belongs to a priority class;

a flag processing unit that sets a value of the flag of the same set as the data to be used in the transaction determined to belong to the priority class, among the data stored in the data storage device, to a value that restricts update by a transaction not belonging to the priority class; and

a transaction execution section that controls execution of the transaction received from the client device, based on optimistic exclusion.

A transaction processing method in a server device, according to a fourth exemplary aspect of the present invention, is a transaction processing method performed by a server device connected between a client device that transmits a transaction and a data storage device that stores a set of data and a flag, the method including

determining whether or not the transaction received from the client device belongs to a priority class;

setting a value of the flag of the same set as the data to be used in the transaction determined to belong to the priority class, among the data stored in the data storage device, to a value that restricts update by a transaction not belonging to the priority class; and

controlling execution of the transaction received from the client device, based on optimistic exclusion.

A program, according to a fifth exemplary aspect of the present invention, causes a computer to function as, the computer constituting a server device connected between a client device that transmits a transaction and a data storage device that stores a set of data and a flag,

a priority determination unit that determines whether or not the transaction received from the client device belongs to a priority class;

a flag processing unit that sets a value of the flag of the same set as the data to be used in the transaction determined to belong to the priority class, among the data stored in the data storage device, to a value that restricts update by a transaction not belonging to the priority class; and

a transaction execution section that controls execution of the transaction received from the client device, based on optimistic exclusion.

As the present invention has the configuration described above, in a transaction processing system in which execution of transactions is controlled based on optimistic exclusion, it is possible to process a particular transaction in preference to other transactions while securing scalability.

### BRIEF DESCRIPTION OF DRAWINGS

FIG. 1 is a block diagram of a first exemplary embodiment of the present invention;

FIG. 2 is a flowchart showing exemplary processing of a server device according to the first exemplary embodiment of the present invention;

FIG. 3 is a flowchart showing details of processing to control execution of a transaction based on optimistic exclusion according to the first exemplary embodiment of the present invention;

FIG. 4 is a block diagram of a data storage device according to an exemplary alteration of the first exemplary embodiment of the present invention;

FIG. 5 is a block diagram of a data storage device according to another exemplary modification of the first exemplary embodiment of the present invention;

FIG. 6 is a block diagram of a second exemplary embodiment of the present invention;

FIG. 7 is a block diagram, in more detail, of the second exemplary embodiment of the present invention;

FIG. 8 is a block diagram of a processing analysis server according to the second exemplary embodiment of the present invention;

FIG. 9 shows an example of priority criteria of the processing analysis server according to the second exemplary embodiment of the present invention;

FIG. 10 shows an exemplary processing request transmitted from a client to the processing analysis server in the second exemplary embodiment of the present invention;

FIG. 11 is a block diagram of a data storage server according to the second exemplary embodiment of the present invention;

FIG. 12 is a flowchart showing exemplary processing of the processing analysis server according to the second exemplary embodiment of the present invention;

FIG. 13 is a flowchart showing exemplary processing of a flag management section of the data storage server according to the second exemplary embodiment of the present invention;

FIG. 14 is a flowchart showing exemplary processing of a processing analysis server according to a third exemplary embodiment of the present invention;

FIG. 15 is a block diagram of a data storage server according to a fourth exemplary embodiment of the present invention;

FIG. 16 is a flowchart showing exemplary processing of a processing analysis server according to the fourth exemplary embodiment of the present invention;

FIG. 17 is a flowchart showing exemplary processing of a processing analysis server according to a fifth exemplary embodiment of the present invention;

FIG. 18 is a block diagram of a processing analysis server according to a sixth exemplary embodiment of the present invention;

FIG. 19 shows an example of priority criteria of the processing analysis server according to the sixth exemplary embodiment of the present invention;

FIG. 20 shows an example of a priority list of the processing analysis server according to the sixth exemplary embodiment of the present invention;

FIG. 21 shows another example of a priority list of the processing analysis server according to the sixth exemplary embodiment of the present invention;

FIG. 22 is a flowchart showing exemplary processing of a processing analysis server according to a seventh exemplary embodiment of the present invention;

FIG. 23 is a flowchart showing exemplary processing of a processing analysis server according to an eighth exemplary embodiment of the present invention;

FIG. 24 is a flowchart showing exemplary processing at the time of receiving a data reflection request of the data storage server according to the eighth exemplary embodiment of the present invention;

FIG. 25 is a flowchart showing exemplary processing at the time of receiving a flag setting request of the data storage server according to the eighth exemplary embodiment of the present invention;

FIG. 26 is a flowchart showing another example of processing of the processing analysis server according to the eighth exemplary embodiment of the present invention;

FIG. 27 is a flowchart showing another example of processing at the time of receiving a data reflection request of the data storage server according to the eighth exemplary embodiment of the present invention;

FIG. 28 is a flowchart showing still another example of processing of the processing analysis server according to the eighth exemplary embodiment of the present invention; and

FIG. 29 is a data configuration diagram for explaining an example of processing performed in a long transaction.

### EXEMPLARY EMBODIMENTS

Next, exemplary embodiments of the present invention will be described in detail with reference to the drawings.

### First Embodiment

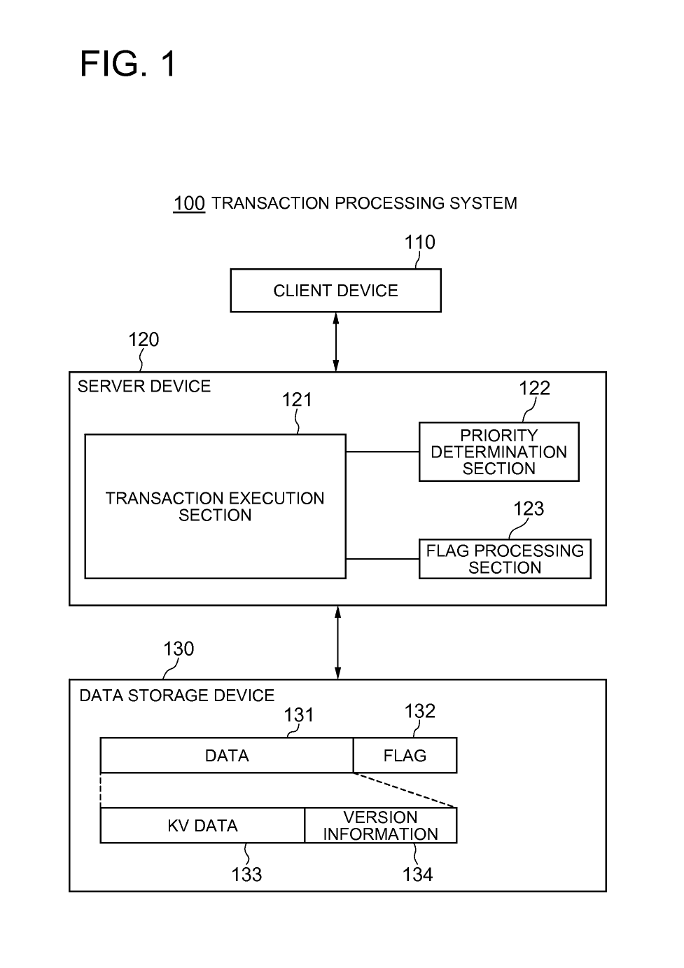

Referring to FIG. 1, a transaction processing system 100 according to a first exemplary embodiment of the present invention includes a client device 110, a server device 120, and a data storage device 130.

The client device 110 is a device which transmits transactions to the server device 120. The client device 110 may be a dedicated or general-purpose computer including a CPU, memories such as ROM, RAM, and the like, an external storage device which stores various types of information, an input/output interface, a communication interface, and buses which connects them with one another, for example. The client device 110 may be plural.

The data storage device 130 has a function of storing one or more sets of data 131 and a flag 132. The flag 132 has a function of restricting update from a transaction other than a transaction belonging to a priority class (that is, not belonging to the priority class) with respect to the data 131 of the same set, by limiting to the case where the value of the flag 132 has a particular value. In the below description, it is assumed that the flag 132 takes either a value 0 or a value 1, and that the flag 132 restricts update from a transaction not belonging to a priority class with respect to the data 131 of the same set, by limiting to the case of a value 1. However, the value to be taken by the flag 132 and the value with which the restriction is valid are not limited to the examples described above.

The data storage device 130 may be a database capable of performing control by optimistic exclusion, that is, a database such as a Berkley DB, a key value store, a relational database, or the like, for example. Further, the data storage device 130 may be plural. Sets of the data 131 and the flag 132, to be stored in the data storage device 130, are stored from time to time in a database of a type described above, according to the data storage method thereof (key value method, relational model method, or the like). In the case of key value store, the data 131 includes KV data 133 and version information 134. The KV data 133 is a pair of a key and a value. The version information 134 represents the version of the KV data 133. Hereinafter, while description will be given based on the premise that the data 131 includes the KV data 133 and the version information 134, the present invention is not limited to data having such a form.

The server device 120 is connected between the client device 110 and the data storage device 130. The server device 120 may be a dedicated or general-purpose computer including a CPU, memories such as ROM, RAM, and the like, an external storage device which stores various types of information, an input/output interface, a communication interface, and buses which connects them with one another, for example. The server device 120 may be plural.

The server device 120 includes a transaction execution section 121, a priority determination section 122, and a flag processing section 123.

The priority determination section 122 has a function of determining whether or not a transaction received from the client device 110 belongs to a priority class. The priority determination section 122 may be realized by a CPU constituting the server device 120 and software executed by the CPU.

In the priority determination section 122, criteria for determining whether or not a transaction belongs to a priority class are arbitrary. For example, the priority determination section 122 may check whether or not information indicating that the transaction belongs to a priority class is added to the transaction received from the client device 110, and if such information is added, determine that it belongs to a priority class, while if not, determine that it does not belong to a priority class. Further, the priority determination section 122 may check whether the number of errors in a transaction is not less than a threshold, and if the number is not less than the threshold, determine that it belongs to a priority class, while if not, determine that it does not belong to a priority class. Further, the priority determination section 122 may check whether or not a required time for executing a transaction is not less than a time of a threshold, and if it is not less than the threshold, determine that it belongs to a priority class, while if not, determine that it does not belong to a priority class. Further, the priority determination section 122 may check whether or not data used for transaction matches the data described in a priority list stored in the server device 120, and if they match, determine that it belongs to a priority class, while if not, determine that it does not belong to a priority class. Further, the priority determination section 122 may use a combination of any two, three or four criteria of the four criteria described above, that is, information indicating that it belongs to a priority class being added, the number of errors of a transaction being not less than a threshold, a required time for executing a transaction is not less than the time of a threshold, and data to be used for a transaction matching the data described in a priority list, and if all of the criteria in the combination are satisfied, determine that it belongs to a priority class, while if not, determine that it does not belong to a priority class. Further, the priority determination section 122 may use criteria other than the four criteria described above.

The flag processing section 123 has a function of setting a value of the flag 132 in the same set as the data used in the transaction determined to belong to a priority class by the priority determination section 122, among the data 131 stored in the data storage device 130, to a value (in an example, a value 1) which restricts update by a transaction not belonging to the priority class. In the case of setting the value of the flag 132 of the data 131 to 1, the flag processing section 123 may check the value of the flag 132 before the setting, or may not check it. In the case of checking it, the flag processing section 123 may omit an operation of setting the value of the flag 132 to 1 if the value of the flag 132 has been set to the value 1, or may rewrites the value to the value 1. The flag processing section 123 may be realized by the CPU constituting the server device 120 and software executed by the CPU.

The transaction execution section 121 has a function of controlling execution of a transaction received from the client device 110, based on optimistic exclusion. The transaction execution section 121 may be realized by the CPU constituting the server device 120 and software executed by the CPU. The transaction execution section 121 may be plural on the same server device 120.

Next, operation of the present embodiment will be described.

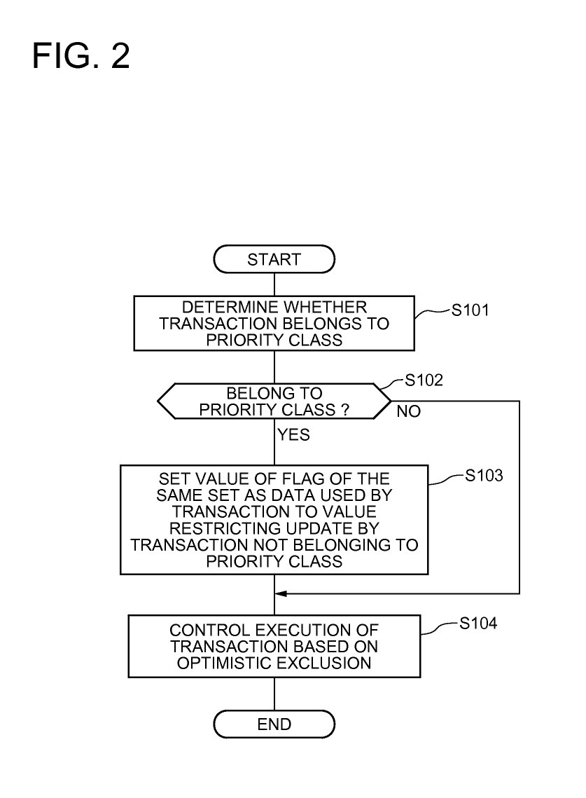

The client device 110 transmits a transaction to the server device 120. Each time the server device 120 receives a transaction, the server device 120 analyzes and executes the transaction. Hereinafter, operation of the server device 120 will be described in more detail with reference to FIG. 2.

The priority determination section 122 of the server device 120 determines whether or not a transaction received from the client device 110 belongs to a priority class (step S101). If it belongs to a priority class (YES at step S102), the flag processing section 123 of the server device 120 sets the value of the flag 132 in the same set as the data 131 used in the transaction, among the data 131 stored in the data storage device 130, to a value which restricts update by a transaction not belonging to the priority class (in the example, a value 1) (step S103). On the other hand, if the transaction received from the client device 110 does not belong to the priority class (NO at step S102), the processing of step S103 is skipped.

Then, the transaction execution section 121 of the server device 120 controls execution of the transaction based on optimistic exclusion (step S104).

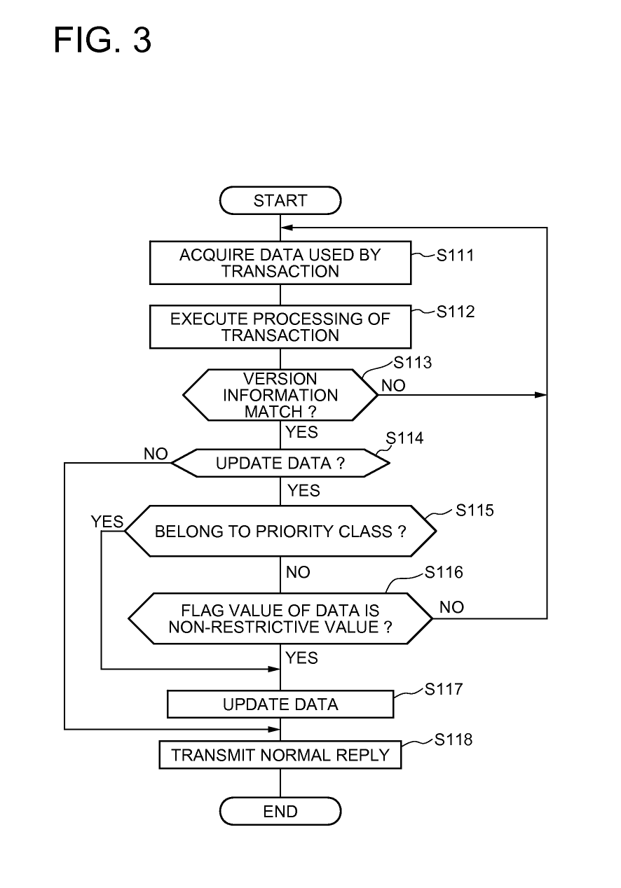

FIG. 3 is a flowchart showing the details of the processing at step S104. Hereinafter, operation of controlling execution of the transaction based on optimistic exclusion by the transaction execution section 121 of the server device 120 will be described with reference to FIG. 3.

First, the transaction execution section 121 acquires the data 131 used in the transaction from the data storage device 130, and saves it on a cache not shown (step S111). Next, the transaction execution section 121 uses the KV data 133 of the data 131 on the cache to execute processing of the transaction (step S112). Then, upon completion of the execution of the processing of the transaction, the transaction execution section 121 executes the following processing.

First, the transaction execution section 121 acquires the version information 134 of the data 131 used in the transaction from the data storage device 130, and determines whether or not it is the same as the version information 134 at the time of starting execution of the transaction (step S113). If it is not the same, as another transaction has updated the same data during a period from the time when the execution of the transaction has started until it is completed, it is determined that a commit failed. As such, the transaction execution section 121 returns to the processing of step S111, and executes the transaction again. It should be noted than in the course of moving from step S113 to step S111, the processing same as that of steps S102 and S103 in FIG. 2 may be executed.

If the version information 134 is the same, the transaction execution section 121 determines whether or not the transaction is an update transaction for updating data (step S114). If it is not an update transaction but a reference transaction which only performs reference of data (NO at step S114), the transaction execution section 121 determines that a commit succeeded. As such, the transaction execution section 121 transmits a success reply, indicating that the transaction has been completed normally, to the client device 110 (step S118), and ends the processing shown in FIG. 3.

On the other hand, if the transaction is an update transaction (YES at step S114), the transaction execution section 121 determines whether or not the transaction is a transaction belonging to the priority class (step S115). If it is a transaction belonging to the priority class, the transaction execution section 121 reflects the content of the data updated by the transaction on the data storage device 130 (step S117). This means that the transaction execution section 121 rewrites the KV data 133 before update to the KV data 133 after update, and increments the version information 134, for example. Then, the transaction execution section 121 determines that a commit succeeded, transmits a success reply indicating that the transaction has been completed normally to the client device 110 (step S118), and ends the processing shown in FIG. 3. However, if the transaction is a transaction not belonging to the priority class (NO at step S115), the transaction execution section 121 acquires the flag 132 of the data 131 to be updated in the transaction from the data storage device 130, and determines whether or not it is a value which does not restrict update (non-restrictive value; in the example, a value 0) by the transaction not belonging to the priority class (step S116). If it is not a non-restrictive value, as data update cannot be performed, the transaction execution section 121 determines that a commit failed, and returns to the processing of step S111 and execute the transaction again. On the other hand, if it is a non-restrictive value, the transaction execution section 121 reflects the content of the data updated by the transaction on the data storage device 130 (step S117), determines that a commit succeeded, and transmits a success reply indicating that the transaction has been completed normally to the client device 110 (step S118), and ends the processing shown in FIG. 3. It should be noted that in the course from step S116 to step S111, the same processing as that of steps S102 and S103 in FIG. 2 may be performed.

In the processing shown in FIG. 3, regarding an update transaction not belonging to the priority class, the transaction execution section 121 confirms that the version information 134 of the data 131 to be used by the transaction is the same as that at the time of starting execution of the transaction, and that the flag 132 of the data 131 to be updated by the transaction has a value which does not restrict update by the transaction not belonging to the priority class, and then commits the transaction. Accordingly, in the case of performing optimistic exclusion using Compare and Swap operation, as for an update transaction not belonging to the priority class, the transaction execution section 121 compares a set of the version information 134 of the data 131 at the time of starting the execution and the value of the flag 132 which does not restrict update, with a set of the version information 134 of the data 131 at the time of completion of the execution and the value of the flag 132, and if they match, the transaction execution section 121 updates (swaps) the data 131 of the data storage device 130 using the data 131 configured of the KV data 133 and the version information 134 after update and determines that a commit succeeded, while if they do not match in the comparison, the update is not performed, and a commit failed.

Further, in the processing shown in FIG. 3, regarding the update transaction belonging to the priority class, the transaction execution section 121 confirms that the version information 134 of the data 131 to be used by the transaction is the same as that at the time of starting execution of the transaction, and then commits the transaction. Accordingly, in the case of performing optimistic exclusion using Compare and Swap operation, as for an update transaction belonging to the priority class, the transaction execution section 121 compares the version information 134 of the data 131 at the time of starting the execution with the version information 134 of the data 131 at the time of completion of the execution, and if they match, the transaction execution section 121 updates (swaps) the data 131 of the data storage device 130 using the data 131 configured of the KV data 133 and the version information 134 after update and determines that a commit succeeded, while if they do not match in the comparison, the update is not performed, and a commit failed.

Next, advantageous effects of the present embodiment will be described.

According to the present embodiment, in the transaction processing system 100 which controls execution of transactions based on optimistic exclusion, it is possible to process a particular transaction in preference to other transactions while securing scalability.

The reason that a particular transaction can be processed in preference to other transaction is that update of the data 131, to be used in a transaction belonging to a priority class, by a transaction not belonging to the priority class is restricted by the flag 132. Thereby, in a plurality of transactions started to be executed before and after, it is possible to prevent the data to be used in a transaction belonging to the priority class from being updated in advance by a transaction not belonging to the priority class. As such, it is possible to prevent a failure in optimistic exclusion in the transaction belonging to the priority class, which may be caused by data update by a transaction not belonging to the priority class.

Further, the reason that scalability can be secured is that determination of whether or not a transaction belongs to the priority class, and an operation of setting the value of a flag, in the same set as the data to be used in a transaction belonging to the priority class, to a value which restricts update by a transaction not belonging to the priority class, can be performed for each transaction independently, without a need to adjust them between transactions.

Based on the configurations described above, various additions and alterations as described below can be made in the present embodiment.

If the value of the flag 132 of the data 131 used in the transaction belonging to the priority class remains as the value which validates restriction after the end of the processing of the transaction, a transaction not belonging to the priority class, which updates the data, will never be able to be executed. As such, a system for restoring the value of the flag 132 to a value which does not restrict update by a transaction not belonging to the priority class may be added. For example, at the time of committing a transaction belonging to the priority class, the transaction execution section 121 may restore the value of the flag 132 of the data 131 used by the transaction to the original value, that is, to a value which does not restrict update by a transaction not belonging to the priority class.

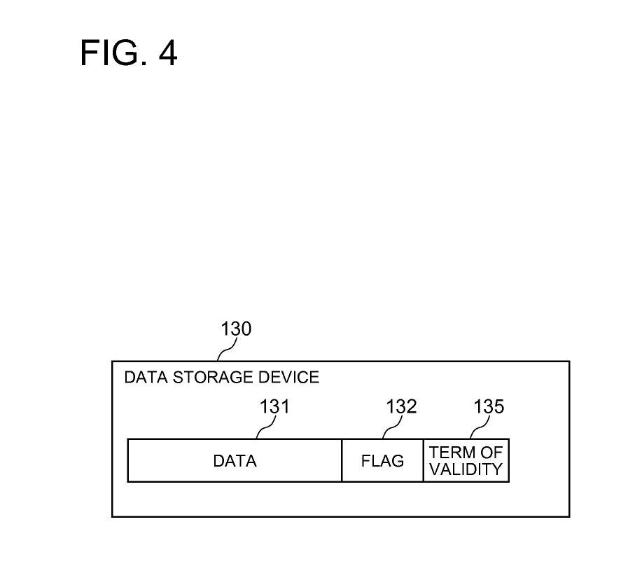

Meanwhile, the data storage device 130 may store the term of validity 135 of the flag 132 as shown in FIG. 4. The term of validity 135 represents, in the case where the value of the flag 132 is set to a value which restricts update by a transaction not belonging to the priority class, the time until when the restriction is valid and after when the restriction becomes invalid. In the case where the value of the flag 132 is set to a value which restricts update by a transaction not belonging to the priority class, the transaction execution section 121 checks the term of validity 135 thereof and determines that the restriction is valid if the term of validity has not expired, while determines that the restriction is invalid if the term of validity has expired. Alternatively, it is also possible to check the term of validity 135 routinely, and processing to restore the value of the flag 132, in which the term of validity has expired, to a value which does not restrict update by a transaction not belonging to the priority class may be performed by the server device 120 or the data storage device 130.

Further, when the flag processing section 123 of the server device 120 sets the value of the flag 132 to a value which restricts update by a transaction not belonging to the priority class, the flag processing section 123 may set the deadline corresponding to the required time for executing the transaction as the term of validity 135 of the flag. For example, if a required time for executing a transaction is assumed to be T, the time after a T period of time has passed from the execution start time of the transaction may be set as the term of validity 135 of the flag. Alternatively, in consideration of an extra period of time Δ, the time after a T+Δ period of time has passed from the execution start time of the transaction may be set as the term of validity 135 of the flag. Thereby, it is possible to set the value of the flag 132 of the data 131 to be used in the transaction to a value which restricts update by a transaction not belonging to the priority class, only for the period during which the transaction belonging to the priority class is in execution. It should be noted that if the term of validity 135 of the flag has been set beforehand, the term of validity 135 may or may not be rewritten to a new term of validity. It is also possible to rewrite the term of validity if the term of validity, having been set beforehand, has expired, while not to rewrite it if it has not expired.

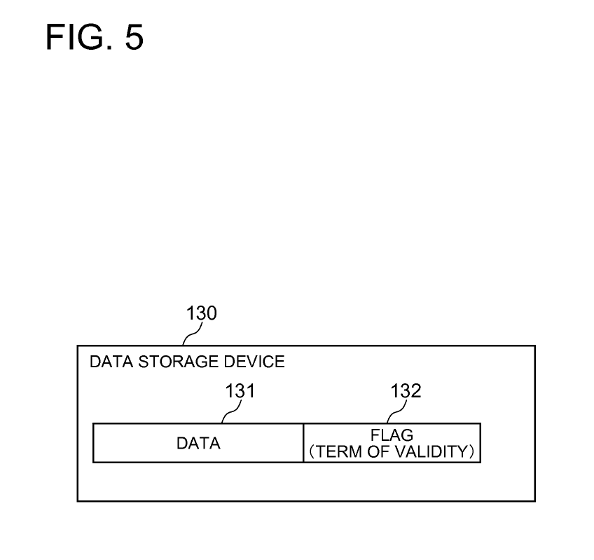

Further, while the term of validity 135 is stored independent of the flag 132 in FIG. 4, the value itself of the flag 132 may be the term of validity, as shown in FIG. 5. In that case, if the term of validity shown by the value of the flag 132 has not expired, the flag 132 has a function of restricting update by a transaction not belonging to the priority class, while if the term of validity has expired, the flag 132 does not have a function of restricting update by a transaction not belonging to the priority class.

### Second Exemplary Embodiment

Next, a second exemplary embodiment of the present invention will be described.

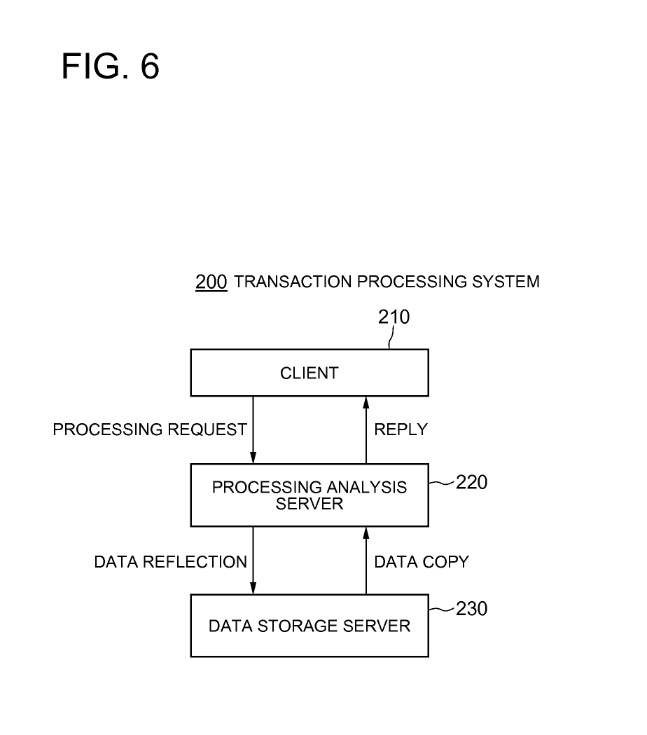

Referring to FIG. 6, a transaction processing system 200 according to the present embodiment includes a client 210, a processing analysis server 220, and a data storage server 230.

In the transaction processing system 200 according to the present embodiment, the client 210 first transmits a processing request to the processing analysis server 220. Here, one processing request corresponds to one transaction. Upon receipt of the processing request from the client 210, the processing analysis server 220 analyze the processing request, copies necessary latest data from the data storage server 230, and performs update and reference processing. After completion of the processing according to the received processing request, the processing analysis server 220 replies to the client 210. While the entire units of processing according to the processing request between the client 210 and the processing analysis server 220 and between the processing analysis server 220 and the data storage server 230 are performed in parallel, data consistency will never be lost. Further, the processing request will never be transmitted directly from the client 210 to the data storage server 230.

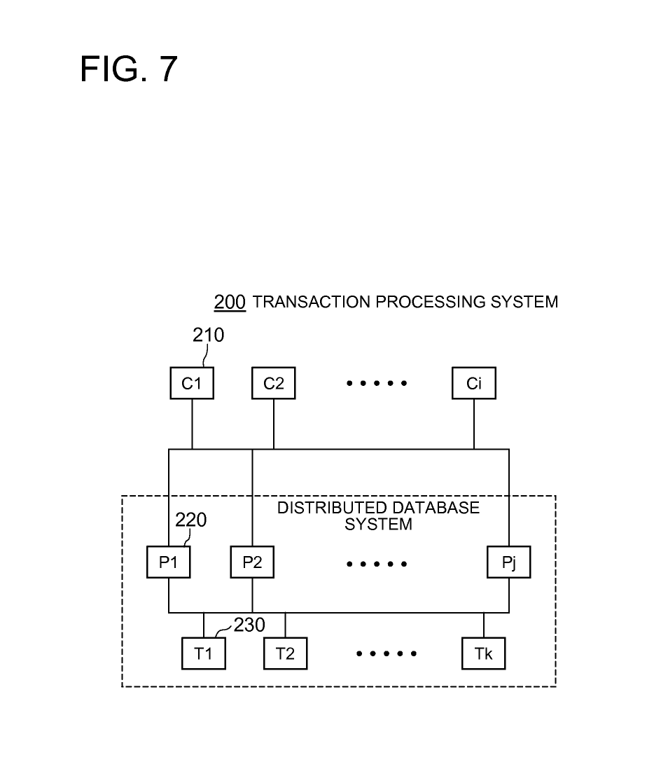

FIG. 7 shows a more detailed configuration of the transaction processing system 200 according to the present embodiment. Referring to FIG. 7, the transaction processing system 200 according to the present embodiment is a distributed database system having i pieces (i represents an integer of 1 or more) of the clients (C) 210. In the distributed database system, there are j pieces (j represents an integer of 1 or more) of the processing analysis servers (P) 220, and k pieces (k represents an integer of 1 or more) of the data storage server (T) 230. As each client 210 is linked to all of the processing analysis servers 220, a processing request can be transmitted to any of the processing analysis servers 220. Further, as each processing analysis server 220 is linked to all of the data storage servers 230, a processing request can be transmitted to any of the data storage servers 230.

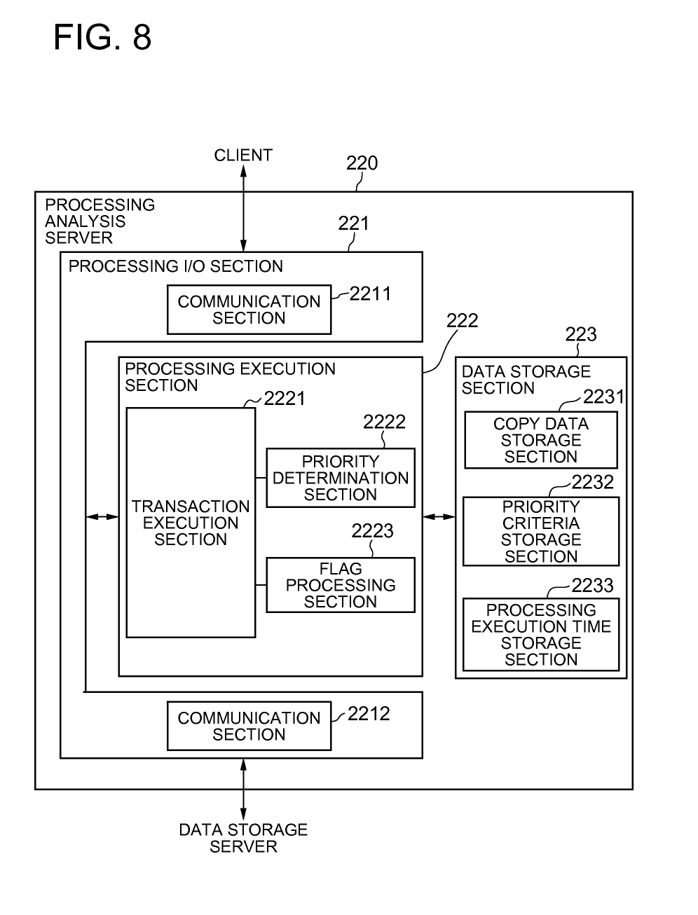

FIG. 8 is a block diagram of the processing analysis server 220. The processing analysis server 220 includes a processing input/output section 221, a processing execution section 222, and a data storage section 223. The processing input/output section 221 includes a communication section 2211 with a client and a communication section 2212 with a data storage server, and performs transmission and reception of processing requests, data, and the like with other functional servers. The processing execution section 222 includes a transaction execution section 2221 which executes processing according to a received processing request, a priority determination section 2222 which determines whether or not the processing request to be executed belongs to a priority class, and a flag processing section 2223 which sets the value of a flag of data to be used by the processing request determined to belong to the priority class by the priority determination section 2222, to a value which restricts update by a processing request not belonging to the priority class. The data storage section 223 includes a copy data storage section 2231 which stores data copied from the data storage server 230, a priority criteria storage section 2232 which stores criteria to determine whether or not a processing request belongs to a priority class, and a processing execution time storage section 2233 which stores the period of time having been taken for executing the processing request.

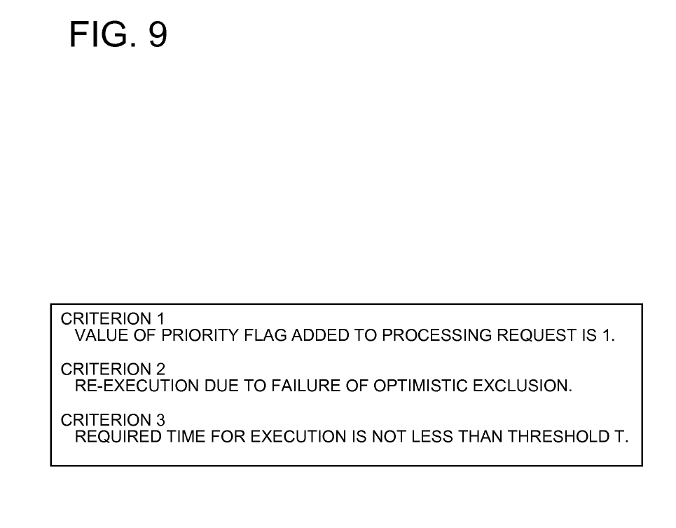

In the present embodiment, the priority criteria storage section 2232 stores three criteria as shown in FIG. 9.

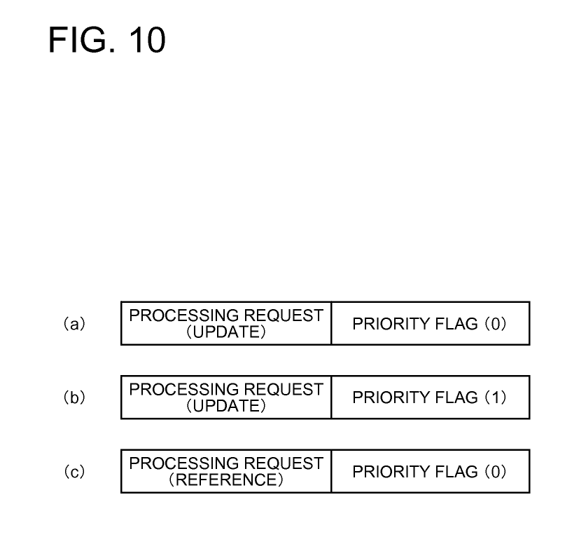

A first criterion is that a priority flag having a value 1 is added to a processing request transmitted from the client 210 to the processing analysis server 220. FIG. 10 shows three processing requests transmitted from the client 210 to the processing analysis server 220. To a processing request shown in FIG. 10(a) and a processing request shown in FIG. 10(c), a priority flag having a value of 0 is added. This means that the client 210 does not wish preferential processing for those processing requests. On the other hand, to a processing request in FIG. 10(b), a priority flag having a value of 1 is added. This means that the client 210 wishes preferential processing for this processing request. The processing request in which the value of the priority flag is 0 will never be processed in preference, regardless of whether or not it satisfies other criteria. On the other hand, the processing request in which the value of the priority flag is 1 will be processed in preference, if it satisfies other criteria.

A second criterion is that execution of a processing request is re-execution due to a failure of optimistic exclusion.

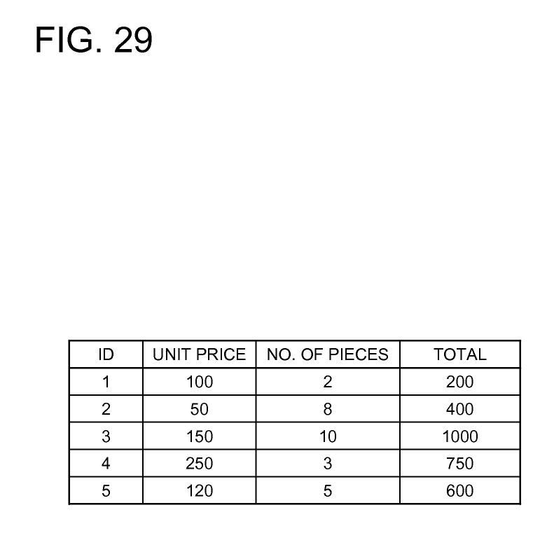

A third criterion is that a period of time required for execution is not less than a threshold T. This means that the third criterion requires a long transaction. As a long transaction requires a long period of time from the start of processing until the end of the processing, there is a high probability that data is updated first by another transaction in which execution is started after the start of the processing. As such, although retry is repeated, optimistic exclusion fails each time and an error occurs. For example, in a transaction TRa which performs update of a unit price of every ID with respect to the data as shown in FIG. 29, first, data of all IDs (ID1 to ID5 in the example) is copied from the data storage server 230 to the copy data storage section 2231, and the data is updated, and then a processing result is reflected on the data storage server 230. In this step, if there are a plurality of other transactions TRb which perform data update processing on the data of each ID, there is a high possibility that update to be performed on each ID is also performed by the other transactions TRb during the time when the processing of the transaction TRa is in execution, and no matter how many times the transaction TRa retries update, an error occurs each time. As such, in the present embodiment, the threshold T is set based on the processing period of time of a long transaction, and a condition that a period of time required for execution is not less than the threshold T is used as a criterion, whereby it is possible to prevent occurrence of continuous errors in a long transaction.

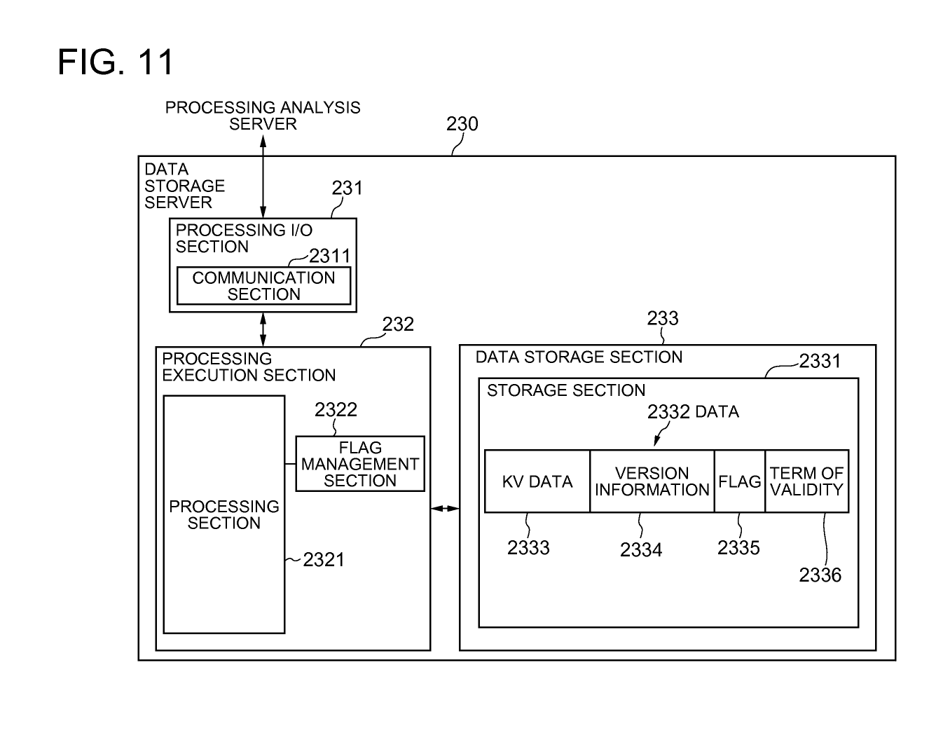

FIG. 11 is a block diagram of the data storage server 230. Similar to the processing analysis server 220, the data storage server 230 includes a processing input/output section 231, a processing execution section 232, and a data storage section 233. The processing input/output section 231 includes a communication section 2311 with the processing analysis server. As the data storage server 230 does not perform communications with the client 210, the data storage server 230 does not have a communication section equivalent to the communication section 2211 with a client in the processing analysis server 220. The data storage section 233 includes a storage section 2331 which stores latest data. Data 2332 to be stored in the storage section 2331 includes KV data 2333, version information 2334, a flag 2335, and a term of validity 2336 of the flag. The KV data 2333 is a pair of a key and a value. The version information 2334 represents the version of the KV data 2333. The flag 2335 takes a value of 0 or 1. If the value of the flag 2335 is 1, update of the KV data 2333 from a processing request not belonging to a priority class is restricted. If the value of the flag 2335 is 0, there is no such restriction. The term of validity 2336 represents, in the case where the value of the flag 2335 is set to a value which restricts update by a transaction not belonging to the priority class, the time until when the restriction is valid and after when the restriction becomes invalid. The processing execution section 232 includes a processing execution section 2321 which performs processing requested from the processing analysis server 220, and a flag management section 2322 which routinely performs processing to update the value of the flag 2335, in which the term of validity has expired, to 0.

Next, operation of the present embodiment will be described.

First, operation of the client 210 will be described. The client 210 transmits a processing request to any of the processing analysis servers 220. At that time, if the client 210 wishes preferential processing, the client 210 transmits the processing request by adding a priority flag having a value 1, and if not, the client 210 transmits the processing request by adding a priority flag having a value 0.

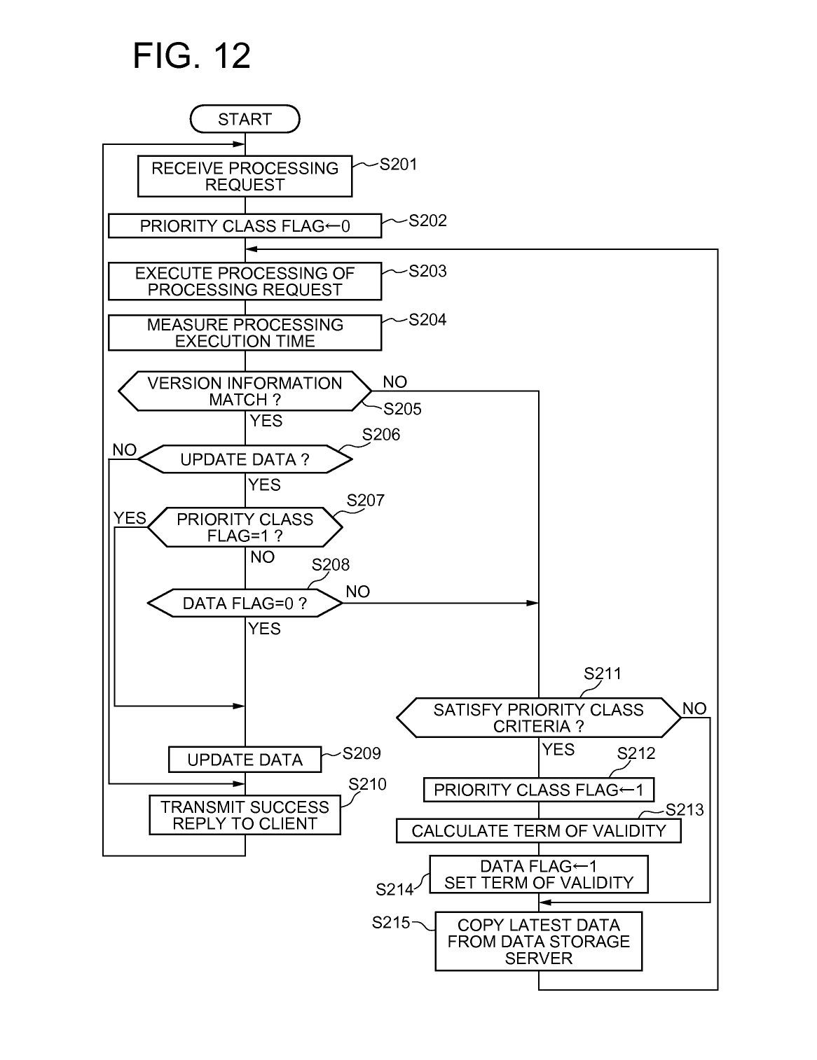

Next, operation of the processing analysis server 220 will be described. FIG. 12 is a flowchart showing exemplary processing by the processing analysis server 220.

When the transaction execution section 2221 of the processing analysis server 220 receives a processing request from the client 210 (step S201), the priority determination section 2222 determines whether or not the processing request belongs to a priority class, and in accordance with the determination result, the transaction execution section 2221 determines the value of a priority class flag given to the processing request (step S202). According to the criteria shown in FIG. 9 stored in the priority criteria storage section 2232, as none of the processing requests satisfy the criterion 2 at the time when received from the client 210, the processing request is determined not to belong to the priority class. As such, to the received processing request, a priority class flag having a value 0, indicating that it does not belong to the priority class, is given.

Then, the transaction execution section 2221 copies data to be referred to and updated in the processing according to the received processing request, from the data storage server 230 to the copy data storage section 2231, and executes processing according to the processing request (step S203). When acquiring a copy, a data acquisition request designating a key is transmitted from the transaction execution section 2221 of the processing analysis server 220 to the processing execution section 2321 of the data storage server 230, and the processing execution section 2321 retrieves the KV data 2333 having the same key from the data storage section 2331, and sends it back to the processing analysis server 220 along with the version information 2334. Further, transaction execution section 2221 of the processing analysis server 220 measures the execution period of time of the processing according to the processing request, and records the measured execution period of time in the processing execution time storage section 2233 (step S204).

Upon completion of the processing according to the processing request, in order to ensure data consistency, the transaction execution section 2221 of the processing analysis server 220 checks whether or not the version information of the data in the data storage server 230 is the same as that at the time of acquiring the data used in the processing according to the processing request (step S205). This means that the transaction execution section 2221 acquires the version information 2334 of the data 2332 used in the processing request from the data storage server 230, and determines whether or not it is the same as the version information 2334 at the time of acquiring the data stored in the copy data storage section 2231. If both units of version information differ from each other, the same data has been updated by another processing request during the period from the start of execution of the processing request until the completion thereof. As such, the transaction execution section 2221 determines that a commit failed, and moves to processing of step S211 in order to retry the processing request.

On the other hand, if both units of version information 2334 match, the transaction execution section 2221 determines whether or not the processing request is an update transaction for updating the data (step S206). If it is not an update transaction but a reference transaction for only referring to the data, the transaction execution section 2221 determines that a commit succeeded, transmits a success reply indicating that the processing request has been completed normally to the client 210 (step S210), returns to the processing of step S201, and receives the next processing request.

If the processing request is an update transaction for updating the data (YES at step S206), the transaction execution section 2221 determines whether or not the processing request belongs to the priority class based on the value of the priority class flag (step S207). If the processing request belongs to the priority class (YES at step S207), the transaction execution section 2221 acquires the content of the data updated by the processing request from the copy data storage section 2231, and reflects it on the data storage server 230 (step S209). This means that the transaction execution section 2221 rewrites the KV data 2333 before update to the KV data 2333 after update, and updates the version information 2334 by incrementing it, for example. Then, the transaction execution section 2221 determines that a commit succeeded, transmits a success reply indicating that the processing request has been completed normally to the client 210 (step S210), and returns to the processing of step S201.

However, if the processing request does not belong to the priority class (NO at step S207), the transaction execution section 2221 acquires the flag 2335 of the data 2332 updated by the processing request from the data storage server 230, and determines whether or not the value is a value which does not restrict update by a processing request not belonging to the priority class (in this example, value 0) (step S208). If the value of the flag 2335 of the data is not a value 0, as data update cannot be performed, the transaction execution section 2221 determines that a commit failed, and moves to the processing of step S211 in order to retry the processing request. Meanwhile, if the value of the flag 2335 of the data is a value 0 which does not restrict update by a processing request not belonging to the priority class, the transaction execution section 2221 reflects the content of the data updated by the processing request on the data storage server 230 (step S209), determines that a commit succeeded, transmits a success reply indicating that the processing request has been completed normally to the client 210 (step S210), and returns to the processing of step S201.

At step S211, the transaction execution section 2221 again determines, by the priority determination section 2222, whether or not the processing request in which the processing having been completed satisfies the criteria of the priority class. According to the criteria in FIG. 9 stored in the priority criteria storage section 2232, the processing request moved from step S208 to step S211 satisfies the criterion 2. As such, the priority determination section 2222 checks the criterion 1 and the criterion 3. When checking the criterion 1, if the value of the priority flag added to the processing request is 1, the priority determination section 2222 determines that it satisfies the criterion 1, and if not, the priority determination section 2222 determines that it does not satisfy the criterion 1. When checking the criterion 3, the priority determination section 2222 reads information of the processing time of the processing request from the processing execution time storage section 2233, compares it with the threshold T, and if the processing execution time is not less than the threshold T, the priority determination section 2222 determines that the criterion 3 is satisfied, while if not, determines that the criterion 3 is not satisfied.

As a result of determination by the priority determination section 2222, if the processing request satisfies all of the criteria 1 to 3, the transaction execution section 2221 performs processing as described below.

First, the transaction execution section 2221 sets the value of the priority class flag of the processing request to 1 (step S212).

Then, the transaction execution section 2221 uses the flag processing section 2223 to calculate the term of validity of the flag (step S213). When calculating the term of validity of the flag, the flag processing section 2223 reads information of the processing time of the processing request from the processing execution time storage section 2233, and calculates a period of time, not less than the processing time of the processing request, as the term of validity of the flag. Further, the flag processing section 2223 may calculate a period of time in which a predetermined extra time α is added to the processing time of the processing request, as the term of validity of the flag. Here, an extra time α may be a period of time calculated by adding a time required for updating the value of the flag in the data storage server, to the time which is two times the time required for communicating a message of a predetermined length between the processing analysis server and the data storage server, for example. The extra time α may not be the same value each time, and it is not necessarily common in every processing.

Then, the transaction execution section 2221 performs update of the flag of the data and setting of the term of validity (step S211). When updating the flag of the data, among the units of data 2332 stored in the data storage section 2331 of the data storage server 230, the flag processing section 2223 updates the value of the flag 2335 of each of all units of data 2332 to be referred to or updated by the processing request to 1, and updates (rewrites) the value of the term of validity 2336 to the value of the term of validity calculated at step S213.

Then, the transaction execution section 2221 moves to the processing of step S215. On the other hand, as a result of determination by the priority determination section 2222, if the processing request does not satisfy at least one criterion of the criteria 1 to 3, the transaction execution section 2221 skips the processing of steps S212 to S214 and moves to the processing of step S215.

At step S215, the transaction execution section 2221 copies latest data to be used by the processing request from the data storage server 230 to the copy data storage section 2231. Then, the transaction execution section 2221 returns to step S201 and re-executes the processing request.

Next, operation of the data storage server 230 will be described. The processing section 2321 in the processing execution section 2321 of the data storage server 230 performs processing corresponding to a read request of the data and a write request of the data 2332 from the processing execution section 222 of the processing analysis server 220. On the other hand, the flag management section 2332 of the processing execution section 232 routinely checks the term of validity 2336 of the flag 2335, and performs processing to restore the value of the flag 2335, in which the term of validity has expired, to a value which does not restrict update by a transaction not belonging to the priority class (in the example, a value 0).

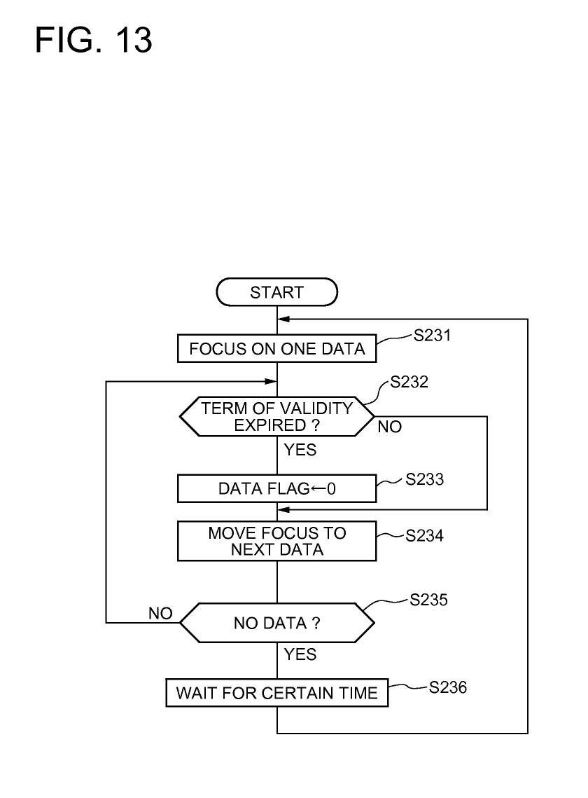

FIG. 13 is a flowchart showing exemplary processing of the flag management section 2322. When the flag management section 2322 starts, the flag management section 2322 focuses on one unit of the data 2332 stored in the storage section 2331 of the data storage section 233 (step S231). Then, the flag management section 2322 compares the term of validity 2336 of the focused data 2332 with the current time to thereby determine whether or not the term of validity has expired (step S232). If the time indicated by the term of validity 2336 is a time older than the current time, the term of validity has expired. As such, the flag management section 2322 sets the value of the flag 2335 of the focused data 2332 to 0 (step S233). Then, the flag management section 2322 moves to the processing of step S234. On the other hand, if the time indicated by the term of validity 2336 is not a time older than the current time, as the term of validity has not expired, the flag management section 2322 skips step S233 and moves to the processing of step S234.

At step S234, the flag management section 2322 moves the focus onto the next unit of the data 2332 stored in the data storage section 233. Then, if there is such data (NO ate step S235), the flag management section 2322 returns to step S232 and performs processing which is the same as the processing described above on the focused data. Meanwhile, if focusing on the entire data 2332 stored in the data storage section 233 has been completed (YES at step S235), after waiting for a certain time (step S236), the flag management section 2322 repeats the operation described above again from the processing of step S231.

Next, advantageous effects of the present embodiment will be described.

According to the present embodiment, in the transaction processing system 200 which controls execution of processing requests (transactions) based on optimistic exclusion, it is possible to process a particular processing request in preference to other processing requests while securing scalability on the same grounds as those of the first exemplary embodiments.

Further, according to the present embodiment, after processing according to a processing request belonging to a priority class has been completed, processing according to a processing request not belonging to the priority class, which updates the same data, can be performed without hindrance. This is because the term of validity 2336 is given to the flag 2335 which restricts update by a processing request not belonging to the priority class, and the flag 2335, in which the processing according to a processing request belonging to the priority class and the term of validity 2336 has expired, is automatically updated to have a value which does not restrict update by a processing request not belonging to the priority class.

Further, according to the present embodiment, the term of validity 2336 of the flag 2335 can be optimized. This is because a period of time required for processing according to a processing request belonging to the priority class is measured, and the term of validity is set based on the measurement value.

Further, according to the present embodiment, at the time of committing a processing request belonging to the priority class, the processing analysis server 220 does not need to perform an operation to restore the value of the flag 2335 of the data used by the processing request to the original value, that is, a value which does not restrict update by a processing request not belonging to the priority class. This is because the data storage server 230 automatically restores the flag 2335, in which the term of validity has expired, to the original value.

Further, according to the present embodiment, it is possible to increase the success probability of a long transaction. This is because a criterion for belonging to the priority class is that a transaction is a long transaction.

Further, according to the present embodiment, it is possible to increase the success probability of a long transaction desired by the client among long transaction. This is because a criterion for belonging to the priority class is that a transaction is one in which a client sets the priority flag to 1.

Further, according to the present embodiment, it is possible to increase the success probability when a long transaction is re-executed. This is because a criterion for belonging to the priority class is that a transaction is one to be re-executed due to a failure of optimistic exclusion.

### Third Exemplary Embodiment

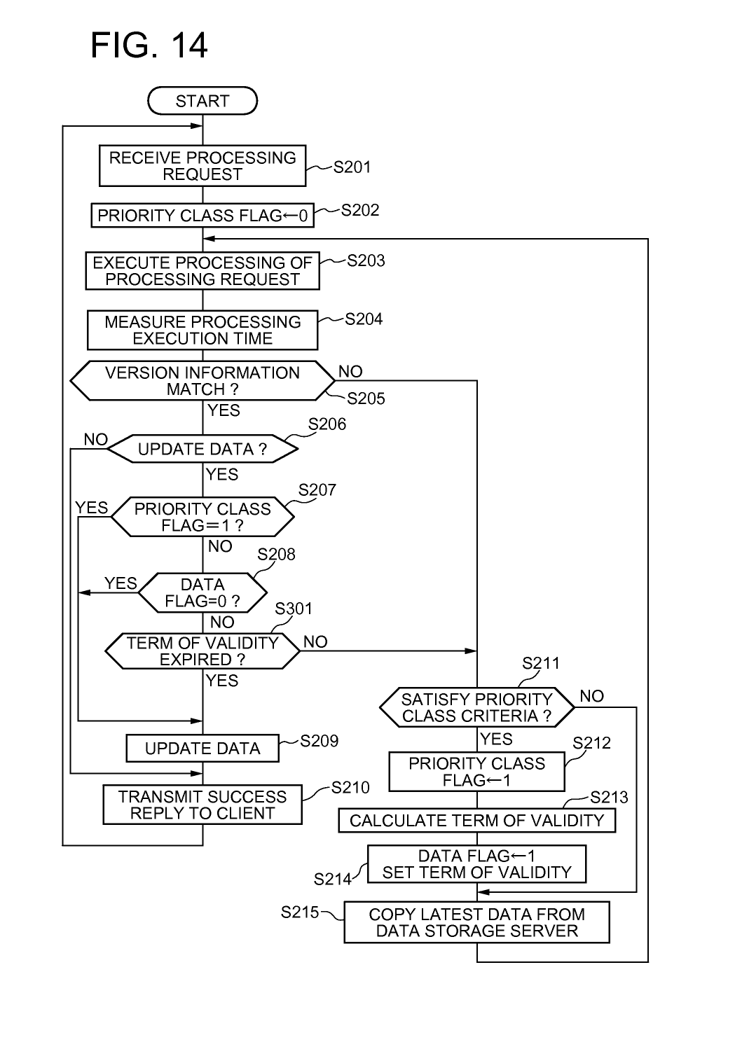

In the second exemplary embodiment described above, the transaction execution section 2221 of the processing analysis server 220 immediately moves to the processing of step S211, in the flowchart shown in FIG. 12, if the value of the flag 2335 of the data is 1 (NO at step S208). The present embodiment differs from the second exemplary embodiment in that if the value of the flag 2335 of the data is 1, the transaction execution section 2221 checks the term of validity 2336 of the flag 2335 (step S301), and if the term of validity has not expired, moves to the processing of step S211, while if the term of validity has expired, moves to the processing of step S209, as shown in the flowchart of FIG. 14.

In the second exemplary embodiment, the flag management section 2322 of the data storage server 230 routinely detects the flag 2335 in which the term of validity has expired, and restore the value. However, as it is a routine operation, the flag 2335 in which the value is not restored even though the term of validity has expired may be caused. The present embodiment prevents a commit failure of a processing request not belonging to the propriety class, due to such a flag 2335 in which the term of validity has expired.

The data storage server of the present embodiment may be the same as the data storage server 230 of the second exemplary embodiment. In that case, regarding the flag in which the flag management section 2322 of the data storage server 230 detects that the term of validity has been expired and restores the value to 0, the processing analysis server 220 does not need to perform determination processing of step S301 in FIG. 14, whereby the amount of processing by the processing analysis server 220 can be reduced.

Further, the data storage server of the present embodiment may be one in which the function of the flag management section 2322 is omitted from the data storage server 230 of the second exemplary embodiment. In that case, the amount of processing by the data storage server 230 can be reduced.

### Fourth Exemplary Embodiment

While, in the second exemplary embodiment, the term of validity 2336 is stored independent of the flag 2335 thereof, in the present embodiment, the value itself of the flag 132 is used as a term of validity.

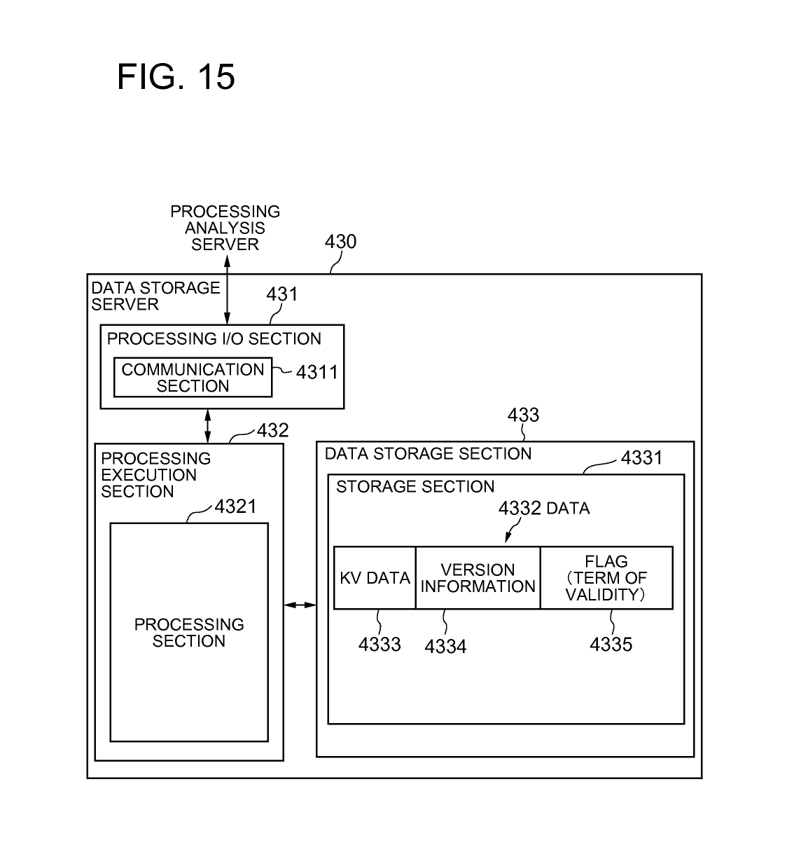

FIG. 15 is a block diagram of a data storage server 430 according to the present embodiment. The data storage server 430 includes a processing input/output section 431, a processing execution section 432, and a data storage section 433. The processing input/output section 431 includes a communication section 4311 with a processing analysis server. The data storage section 433 includes a storage section 4331 which stores latest data. Data 4332 to be stored in the storage section 4331 includes KV data 4333, version information 4334, and a flag 4335. The KV data 4333 is a pair of a key and a value. The version information 4334 represents the version of the KV data 4333. The flag 4335 indicates a term of validity. If the term of validity indicated by the flag 4335 is a time older than the current time, the flag 4335 restricts update of the KV data 4333 from a processing request not belonging to a priority class. If the term of validity indicated by the flag 4335 is not a time older than the current time, the flag 4335 does not restricts update of the KV data 4333 by a processing request not belonging to the priority class. The initial value of the flag 4335 is a time older than the current time. The processing execution section 432 includes a processing section 4321 which performs processing requested by the processing analysis server.

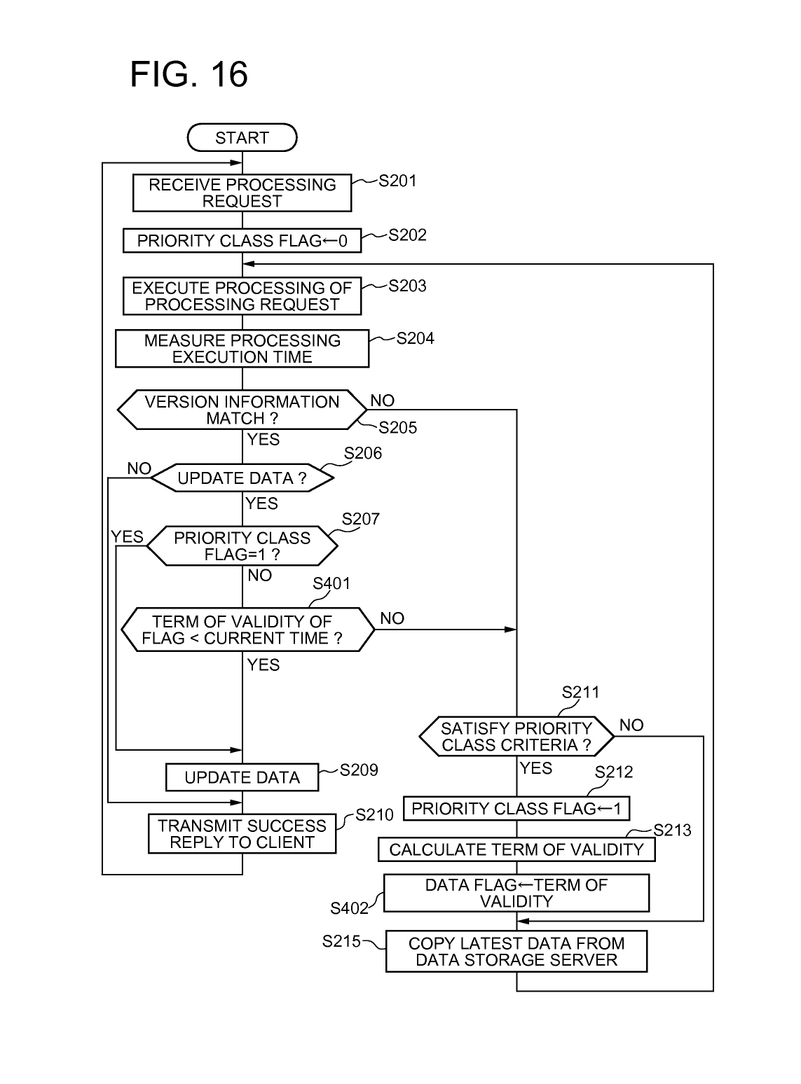

The processing analysis server of the present embodiment is basically the same as the processing analysis server 230 of the second exemplary embodiment. However, the processing analysis server 230 of the present embodiment performs processing shown in FIG. 16, instead of the processing of FIG. 12. Hereinafter, operation of the processing analysis server 230 according to the present embodiment will be described focusing on the difference from the second exemplary embodiment.

In the processing of FIG. 16 executed by the transaction execution section 2221 of the processing analysis server 220, the processing other than that of steps S401 and S402 is the same as the processing shown in FIG. 12.

At step S401 in FIG. 16, the transaction execution section 2221 acquires the flag 4335 of the data 4332 from the data storage server 430, and determines whether or not the term of validity indicated by the flag 4335 is older than the current time. If, the term of validity indicated by the flag 4335 is not older than the current time, the transaction execution section 2221 determines that a commit failed because update of data according to a processing request not belonging to the priority class cannot be performed, and moves to the processing of step S211 in order to retry the processing request. On the other hand, if the term of validity indicated by the flag 4335 is older than the current time, the transaction execution section 2221 reflects the content of the data updated by the processing request on the data storage server 430 (step S209), transmits a success reply indicating that the processing request has been completed normally to the client (step S210), and returns to the processing of step S201.

At step S211, the transaction execution section 2221 determines again, by the priority determination section 2222, whether or not the processing request, in which the processing has been completed, satisfies the criteria for the priority class. As a result of determination by the priority determination section 2222, if the processing request satisfies the entire determination criteria, the transaction execution section 2221 sets the value of the priority class flag of the processing request to 1 (step S212) and calculates the term of validity of the flag (step S213), which is the same as the case of the second exemplary embodiment. Then, in the present embodiment, the transaction execution section 2221 sets the term of validity, calculated at step S213, to the flag 4335 of the data in the data storage server 430 (step S402). Then, the transaction execution section 2221 moves to the processing of step S215. On the other hand, as a result of determination by the priority determination section 2222, if the processing request does not satisfy at least one determination criterion among the determination criteria, the transaction execution section 2221 skips the processing of steps S212, S213, and S402, and moves to the processing of step S215. At step S215, the transaction execution section 2221 copies latest data to be used by the processing request, from the data storage server 430 to the copy data storage section 2231. Then, the transaction execution section 2221 returns to step S203, and re-executes the processing request.

In this way, according to the present embodiment, as the value itself of the flag 4335, which restricts update of data by a processing request not belonging to the priority class, is used as the term of validity, it is possible to reduce the amount of data compared with the configuration in which the value of the flag and the term of validity thereof are stored independently.

### Fifth Exemplary Embodiment

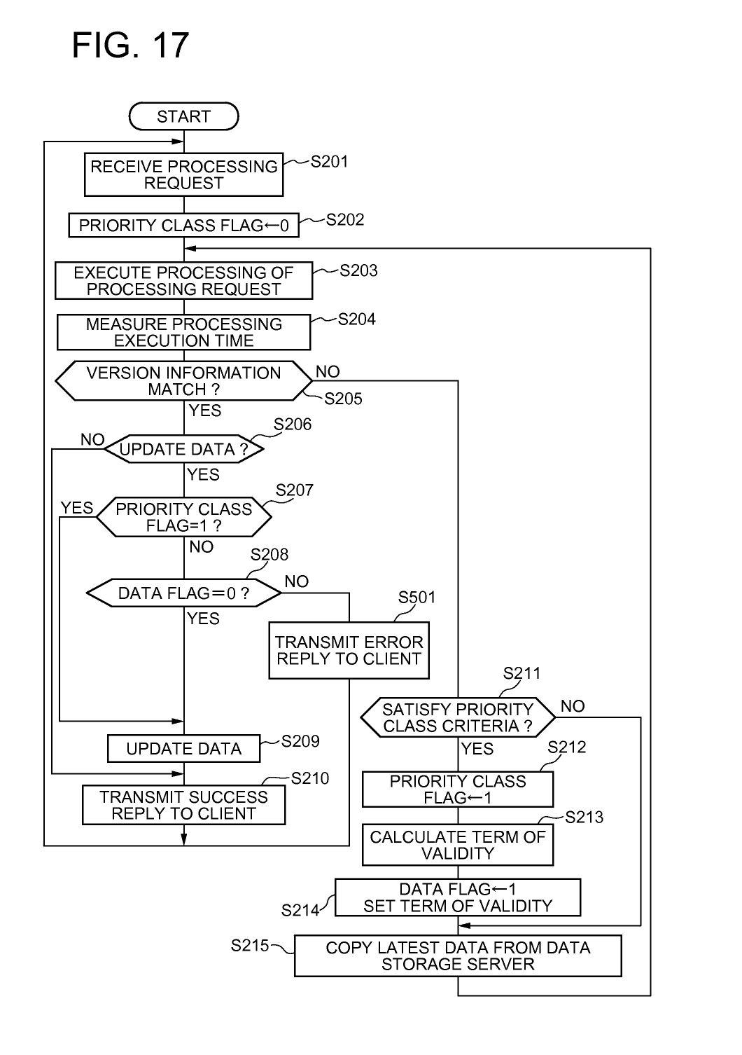

In the second exemplary embodiment, in the flowchart shown in FIG. 12, if the value of the flag 2335 of the data is 1 (NO in step S208), the transaction execution section 2221 of the processing analysis server 220 moves to the processing of step S211 and re-executes the processing request. The present embodiment differs from the second exemplary embodiment in that if the value of the flag 2335 of the data is 1, the transaction execution section 2221 transmits an error reply to the client (step S501), and returns to step S201 to thereby receive the next processing request from the client, as shown in the flowchart of FIG. 17.

If the value of the flag 2335 of the data, in which a processing request not belonging to a priority class desires to update, is 1, the processing request not belonging to the priority class results in error continuously until the value of the flag 2335 becomes 0. The effect thereof is particularly remarkable in the case where a processing request belonging to the priority class is a long transaction. As such, in the present embodiment, if the value of the flag 2335 of the data, in which a processing request not belonging to the priority class desires to update, is 1, the processing request is caused to result in an error without being re-executed, and the processing of the processing analysis server is caused to proceed to the next processing request. Thereby, if the next processing request is a processing request only involving reference, or a processing request for performing update of data which is different from that of a processing request belonging to the priority class, it is possible to continue operation without any stagnation, whereby throughput of the entire system can be improved.

While the present embodiment is based on the second exemplary embodiment, it may be based on the third or fourth exemplary embodiment. In the case where the present embodiment is based on the third exemplary embodiment, if the determination at step S301 in FIG. 14 is NO, the processing request is caused to result in an error. Further, in the case where the present embodiment is based on the fourth exemplary embodiment, if the determination at step S401 in FIG. 16 is NO, the processing request is caused to result in an error.

### Sixth Exemplary Embodiment

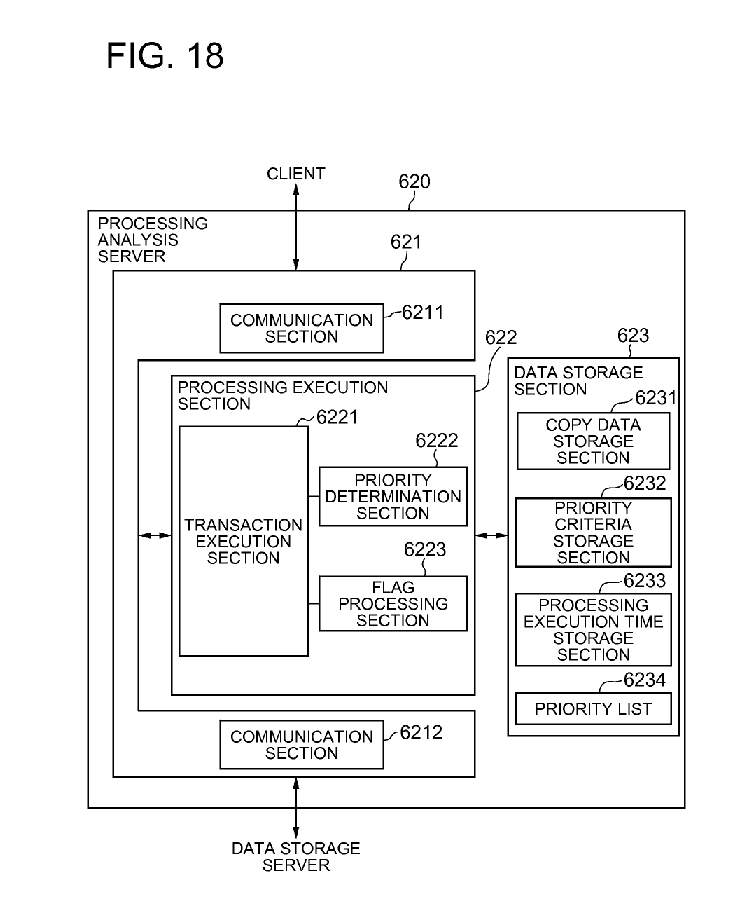

FIG. 18 is a block diagram of a processing analysis server of the present embodiment. A processing analysis server 620 includes a processing input/output section 621, a processing execution section 622, and a data storage section 623. The processing input/output section 621 includes the communication section 6211 and the communication section 6212. The processing execution section 622 includes a transaction execution section 6221, a priority determination section 6222, and a flag processing section 6223. The data storage section 623 includes a copy data storage section 6231, a priority criteria storage section 6232, a processing execution period storage section 6233, and a priority list 6234. Among them, the elements other than the priority criteria storage section 6232, the priority list 6234, and the priority determination section 6222 are the same as the corresponding elements in the second exemplary embodiment.

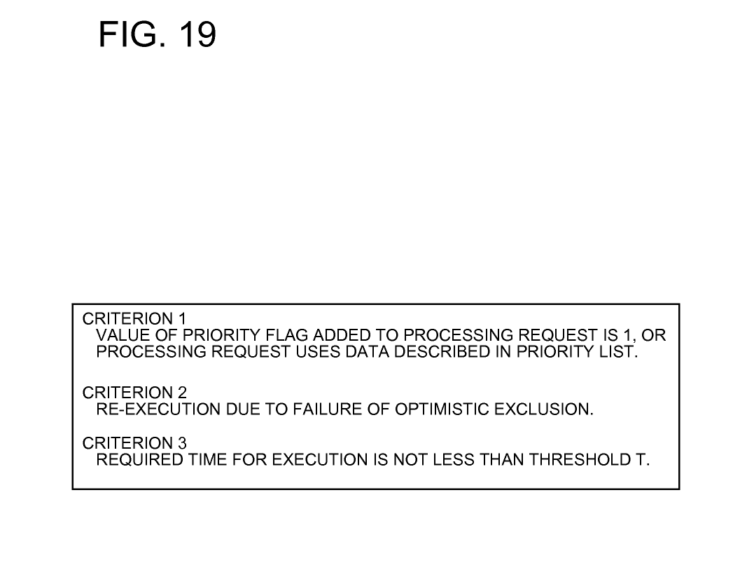

In the present embodiment, the priority criteria storage section 6232 stores three criteria shown in FIG. 19. Criteria 2 and 3 are the same as the criteria 2 and 3 in FIG. 9 in the second exemplary embodiment. Criterion 1 is that a priority flag having a value 1 is added to a processing request transmitted from a client to the processing analysis server 620, or that a processing request is one which refers to data described in the priority list 6234.

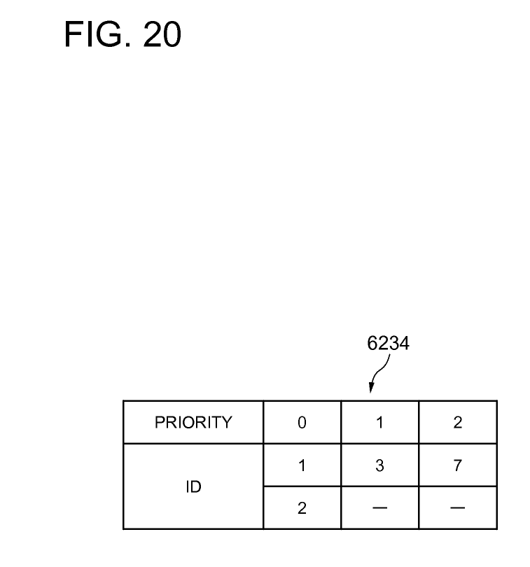

An example of the priority list 6234 is shown in FIG. 20. In the figure, ID is an identifier which uniquely identifies data. Further, priority represents the degree of relative priority of the respective columns in the list, in which 0 is the highest, 1 is the second, and 2 is the lowest. The priority only uses partial columns in the priority list 6234. This means that the columns to be used in the list are limited by a priority designation given to the priority determination section 6222 from the outside. For example, if a priority 1 is given as a priority designation from the outside, two columns of priorities 0 and 1, among the three columns in the priority list 6234, are used. Hereinafter, the case of using the entire columns, without applying a priority designation, will be described. It should be noted that if the entire columns are used regularly, the priority described above may be omitted.

In the first column of the priority list 6234, ID=1 and ID=2 are described. This represents that if data required for transaction processing includes data of ID=1 and data of ID=2, the transaction satisfies the criterion 1. Further, the second column represents that if data required for transaction processing includes data of ID=3, the transaction satisfies the criterion 1. Further, the third column represents that if data required for transaction processing includes data of ID=7, the transaction satisfies the criterion 1.

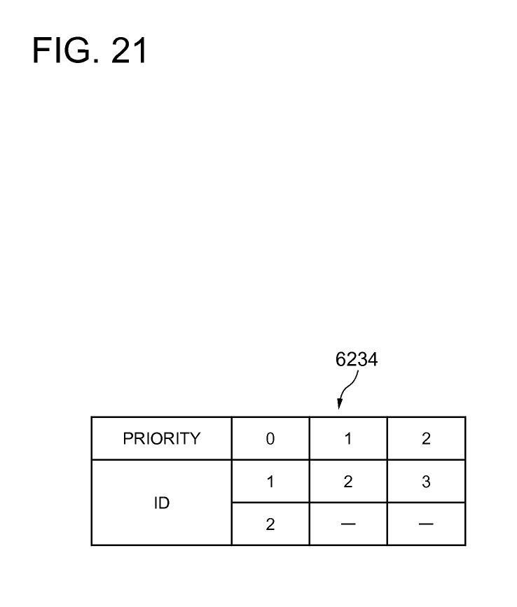

In the priority list 6234 shown in FIG. 20, a processing request only using either one of the data of ID=1 and ID=2 does not satisfy the criterion 1. If it is desired to make a setting to perform priority processing when data of ID=2 is used regardless of usage of the data of ID=1, but when the data of ID=1 is used, to perform priority processing only when the data of ID=2 is used together, it is only necessary to make a priority list as shown in FIG. 21.

In the present embodiment, when the priority determination section 6222 of the processing analysis server 620 determines whether or not a processing request belongs to the priority class, the priority determination section 6222 refers to the priority list 6234. Then, if the processing request refers to or update every data described in any column of the priority list 6234, the priority determination section 6222 determines that it satisfies the criterion 1. If the processing request satisfies the criterion 1, the priority determination section 6222 determines whether or not it satisfies the remaining criteria 2 and 3, and if it satisfies all of the criteria 1 to 3, the priority determination section 6222 determines that the processing request belongs to the priority class.

Next, advantageous effects of the present embodiment will be described. If a client desires preferential processing for a processing request which refers to or updates some data, in the second exemplary embodiment, the client needs to add a priority flag having a value 1 to the processing request by oneself, and transmits it to the processing analysis server 620. On the other hand, in the present embodiment, by setting the priority list 6234 in advance, as for a processing request which refers to or updates predetermined data, it is handled in the same manner as the case of adding a priority flag having a value 1, without adding a priority flag having a value 1 to the processing request.

Further, in the present embodiment, even for a processing request not using data described in the priority list 6234, a processing request to which a priority flag having a value 1 is added by a client can be handled in the same manner as a processing request which uses data described in the priority list 6234. However, an embodiment in which a condition that “the value of priority flag added to a processing request is 1” is deleted from the criterion 1 shown in FIG. 19, is also acceptable.

### Seventh Exemplary Embodiment

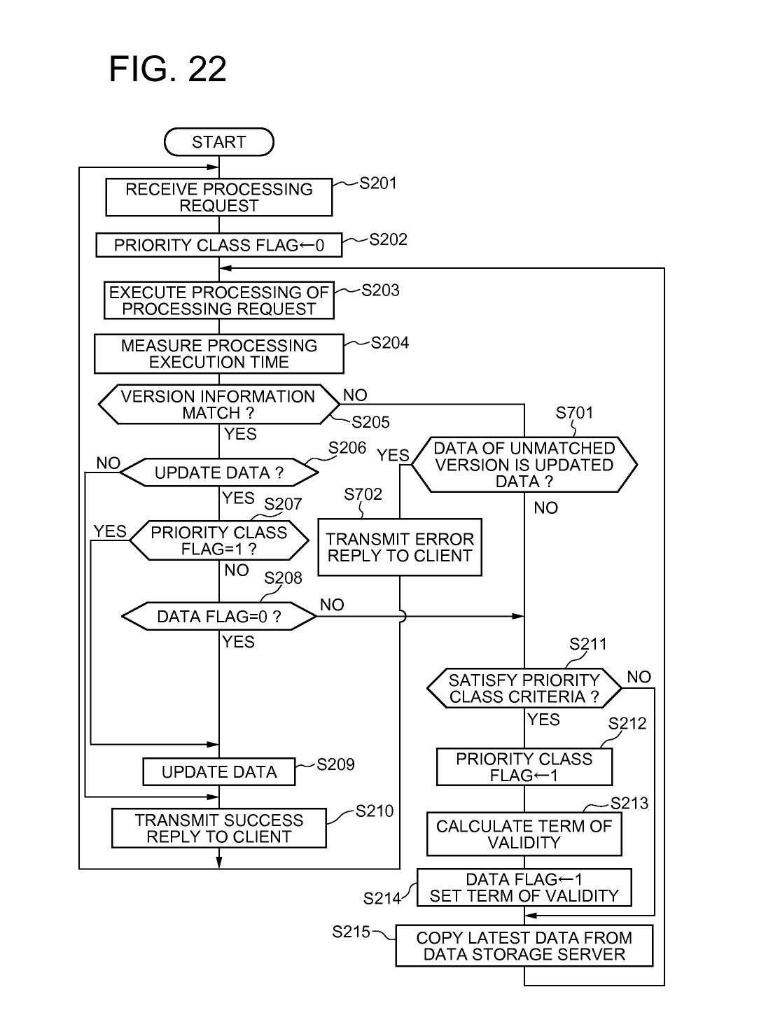

In the second exemplary embodiment, in the flowchart shown in FIG. 12, if the version information of the data does not match (NO at step S205), the transaction execution section 2221 of the processing analysis server 220 immediately moves to the processing of step S211. In the present embodiment, if the version information of the data does not match, the transaction execution section 2221 checks whether or not the data, in which the version information does not match, is updated data (step S701), as shown in the flowchart of FIG. 22. Then, if the version of the updated data does not match (YES at step S701), the transaction execution section 2221 transmits an error reply to the client without performing re-execution of the processing request (step S702), returns to the processing of step S201, and receives the next processing request from the client. On the other hand, if the data, in which the version information does not match, is not updated data but referred data (NO at step S701), the transaction execution section 2221 moves to step S211 and re-executes the processing request, as in the case of the second exemplary embodiment.

In this way, according to the present embodiment, at the time of completion of processing according to a processing request, in the case where the version information of the data used in the processing request is changed, the transaction execution section 2221 is able to return an error to the client without performing re-execution if the change is caused by the updated data. As such, the client is able to determine whether or not to execute the processing request again upon checking the updated value. For example, when a processing request for updating the value shown by the original data to a double value is executed, if the value has been updated, the client may wish to execute the processing again after checking the updated value. The present embodiment is able to meet such a request.

While the present embodiment is based on the second exemplary embodiment, the present embodiment may be based on the third to sixth embodiments.

### Eighth Exemplary Embodiment

While, in the second exemplary embodiment, the processing analysis server 220 performs calculation of a term of validity of a flag, setting of the value of a flag, and writing of the term of validity by itself, in the present embodiment, such processing is performed by the data storage server 230 in accordance with a request from the processing analysis server 220. Further, in second exemplary embodiment, upon completion of execution of the processing according to a processing request, the processing analysis server 220 checks whether or not the version information of the data used in the processing request is changed, checks the value of the flag of the data, and the like by itself. However, in the present embodiment, such processing is performed by the data storage server 230 in accordance with a request from the processing analysis server 220.

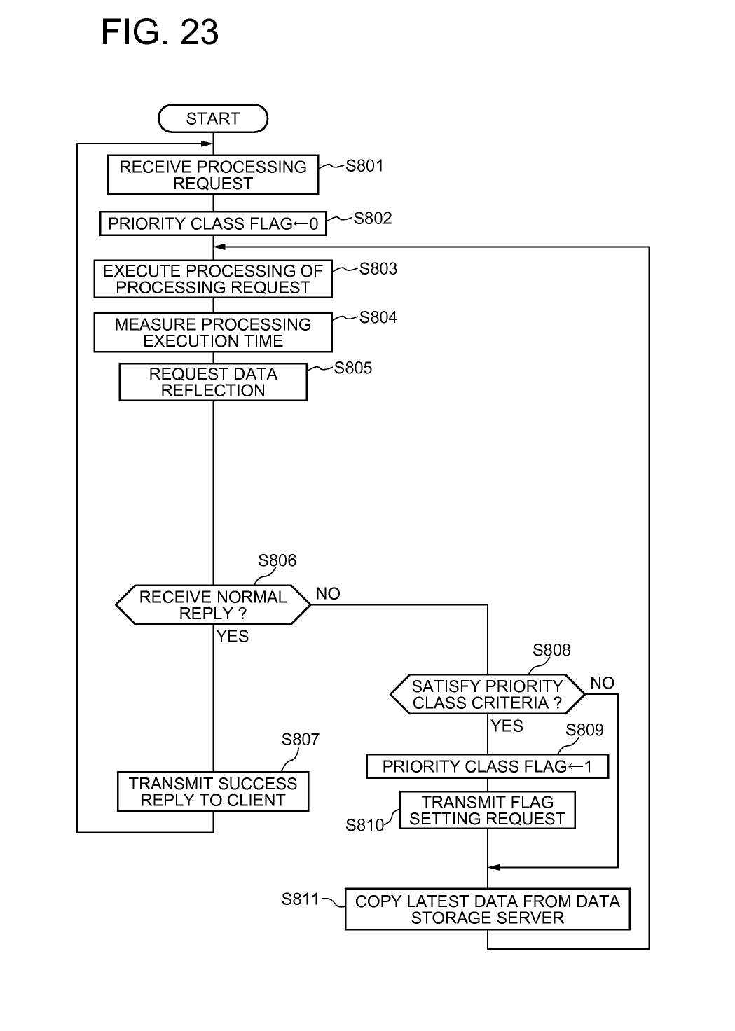

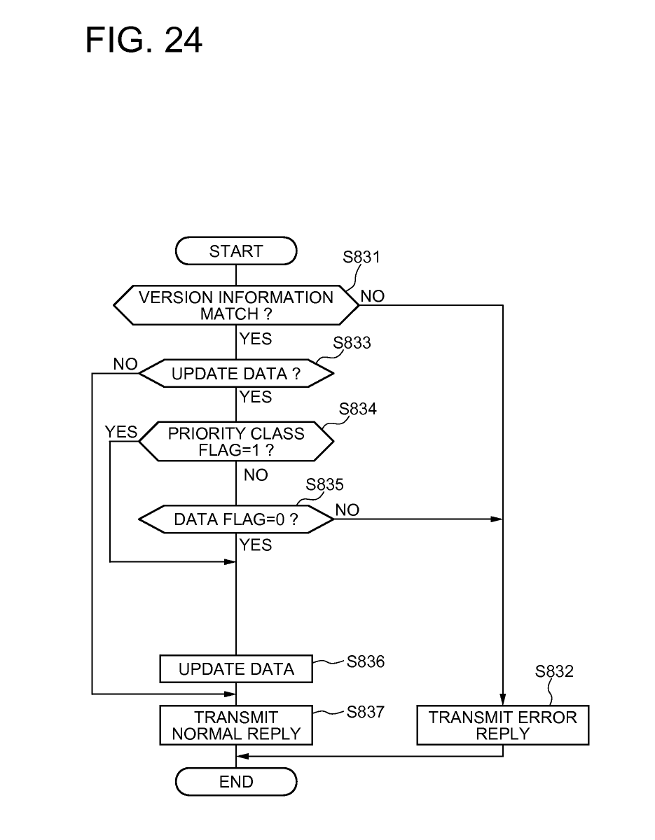

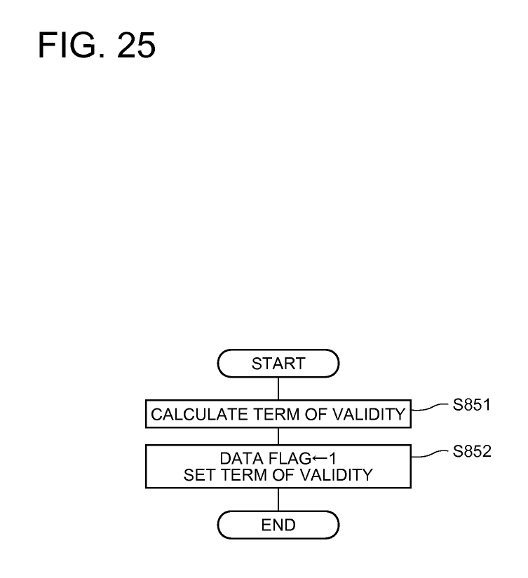

In the present embodiment, the transaction execution section 2221 in the processing execution section 222 of the processing analysis server 220 executes processing shown in FIG. 23, instead of the processing shown in FIG. 12. Further, in the present embodiment, the processing section 2321 in the processing execution section 232 of the data storage server 230 has a function of executing processing shown in FIGS. 24 and 25.

In FIG. 23, the processing of steps S801 to S804 is the same as the processing of steps S201 to S204 in FIG. 12. After completion of the processing according to a processing request, in order to ensure the data consistency, the transaction execution section 2221 of the processing analysis server 220 transmits a data reflection request including the value of the priority class flag of the processing request and information relating to data to be referred to and updated, to the data storage server 230 (step S805). The information relating to data to be referred to and updated include identification information (e.g., a key) of the data to be referred to or updated, version information, and updated data regarding data to be updated.

FIG. 24 is a flowchart showing exemplary processing to be executed by the processing section 2321 of the data storage server 230 which received the data reflection request. The processing section 2321 of the data storage server 230 checks whether or not the current version information 2334 of the data specified by the data identifier included in the data reflection request is the same as the version information included in the data reflection request (step S831). If both units of version information differ from each other, the processing section 2321 transmits an error reply to the processing analysis server 220 (step S832).

On the other hand, if both units of version information 2334 match, the processing section 2321 determines whether or not the processing request is an update transaction for updating the data (step S833). If it is not an updated transaction but a reference transaction which only refers to the data, the processing section 2321 transmits a normal reply to the processing analysis server 220 (step S837).

Meanwhile, if the processing request is an update transaction for updating data (YES at step S833), the processing section 2321 determines whether or the priority class flag of the processing request has a value 1, that is, whether or not it belongs to a priority class (step S834). If it is a processing request belongs to the priority class (YES at step S834), the processing section 2321 rewrites the KV data 2333 before update in the data storage section 233 to the data after update included in the processing request, and updates it by incrementing the version information 2334, for example (step S836). Then, the processing section 2321 transmits a normal reply to the processing analysis server 220 (step S837).

However, if the processing request is a processing request not belonging to the priority class (NO at step S834), the processing section 2321 reads the flag 2335 of the data 2332, which is the update target in the processing request, from the data storage section 233, and determines whether or not it is a value (in this example, value 0) which does not restrict update by a processing request not belonging to the priority class (step S835). If the flag 2335 of the data is not a value 0, as update cannot be performed, the processing section 2321 transmits an error reply to the processing analysis server 220 (step S832). Further, if the flag 2335 of the data is a value 0 which does not restrict update by a processing request not belonging to the priority class, the processing section 2321 rewrites the KV data 2333 before update in the data storage section 233 to the date after update included in the processing request, and increments the version information 2334, for example (step S836). Then, the processing section 2321 transmits a normal reply to the processing analysis server 220 (step S837).

The transaction execution section 2221 receives a reply to the data reflection request from the data storage server 230, and determines whether or not it is a normal reply (step S806 in FIG. 23). If the reply is a normal reply, the transaction execution section 2221 transmits a success reply to the client (step S807). On the other hand, if the reply is an error reply, the transaction execution section 2221 moves to the processing of step S808.

At step S808, the transaction execution section 2221 determines, by the priority determination section 2222, whether or not the processing request, in which the processing has been completed, satisfies the criteria of the priority class. As a result of determination by the priority determination section 2222, if the processing request satisfies all of the criteria 1 to 3, the transaction execution section 2221 performs the following processing.

First, the transaction execution section 2221 sets the value of the priority class flag of the processing request to 1 (step S809). Then, the transaction execution section 2221 transmits a flag setting request to the data storage server 230 (step S810). The flag setting request includes identification information (e.g., key) of the data to be used in the processing request, and information of a processing time of the processing request. Then, the transaction execution section 2221 moves to the processing of step S811.

On the other hand, as a result of the determination by the priority determination section 2222, if the processing request does not satisfy at least one of the criteria 1 to 3, the transaction execution section 2221 skips the processing of steps S809 to S810, and moves to the processing of step S811.

At step S811, the transaction execution section 2221 copies latest data to be used by the processing request from the data storage server 230 to the copy data storage section 2231. Then, the transaction execution section 2221 returns to step S803, and re-executes the processing request.

FIG. 25 is a flowchart showing exemplary processing executed by the processing section 2321 of the data storage server 230 which received the flag setting request. The processing section 2321 of the data storage server 230 calculates the term of validity of the flag from the processing time of the processing request included in the flag setting request (step S851). Calculation of the term of validity of the flag is the same as calculation of the term of validity performed by the flag processing section 2223 of the processing analysis server 220.

Then, the processing section 2321 of the data storage server 230 performs update of the flag of the data and setting of the term of validity (step S852). In the update of the flag of the data, among the data 2332 stored in the data storage section 2331 of the data storage server 230, the flag processing section 2223 updates the values of the flags 2335 of all units of the data 2332, specified by the data identification information included in the flag setting request, to 1, and updates the value of the term of validity 2336 to the value of the term of validity calculated at step S851.

In this way, the present embodiment can reduce the load on the processing analysis server 220, compared with the second exemplary embodiment. This is because processing such as calculation of a term of validity, setting of a value of a flag, and writing of the term of validity, which is performed by the processing analysis server 220 itself in second exemplary embodiment, is performed by the data storage server 230 in accordance with a request from the processing analysis server 220 in the present embodiment. Further, the processing such as checking of version information, checking of a flag value of data, and the like, which is performed by the processing analysis server 220 itself in the second exemplary embodiment, is performed by the data storage server 230 in accordance with a request from the processing analysis server 220 in the present embodiment.

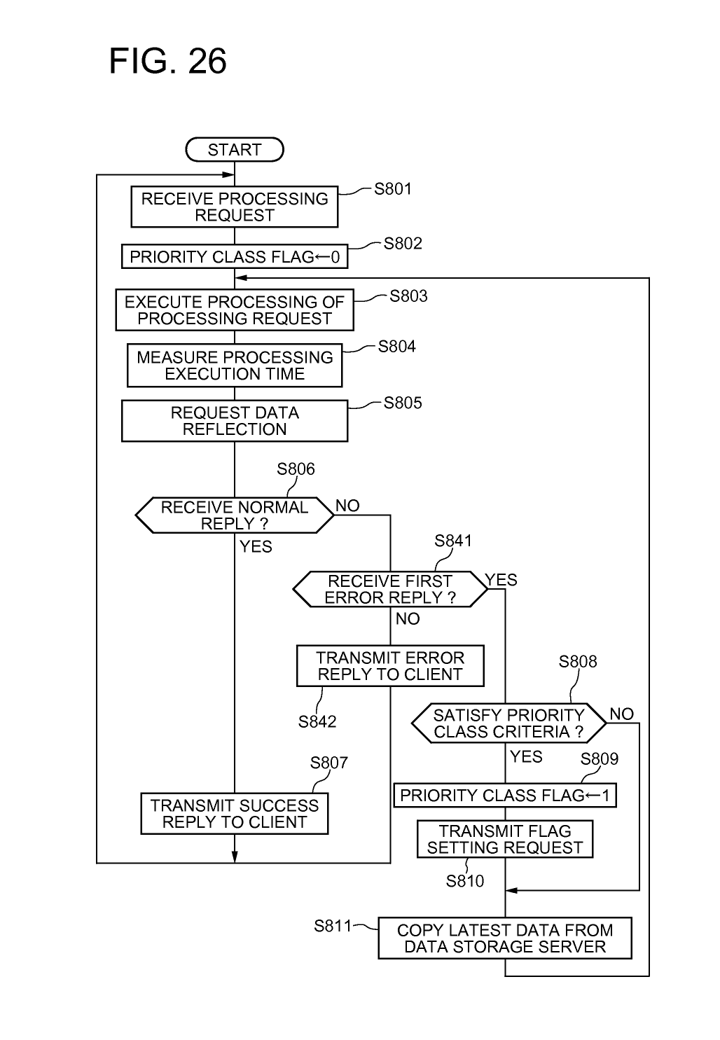

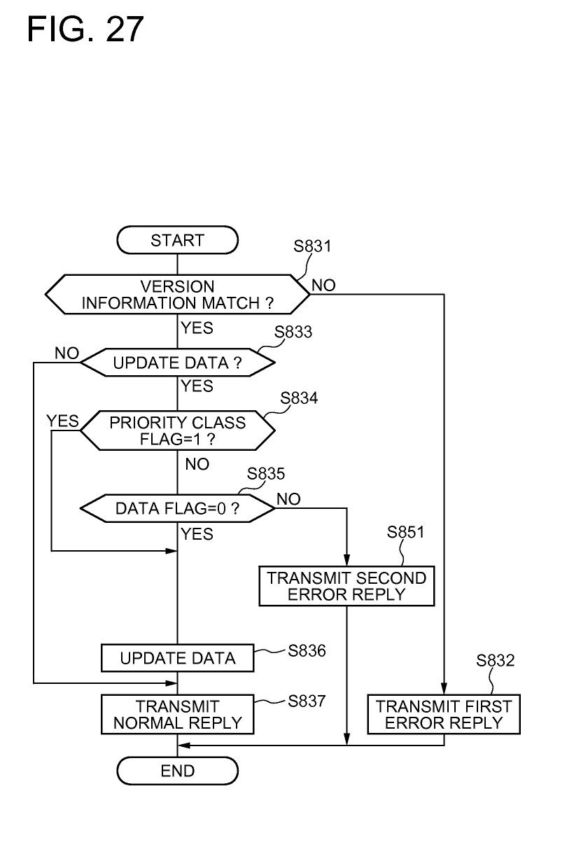

While the present embodiment is based on the second exemplary embodiment, it may be based on the third to seventh exemplary embodiments. It should be noted that if the present embodiment is based on the fifth exemplary embodiment, the processing analysis server performs processing of FIG. 26 instead of the processing of FIG. 23, and the data storage server performs processing of FIG. 27 instead of the processing of FIG. 24. Referring to FIG. 27, if the version information does not match, the data storage server transmits a first error reply to the processing analysis server (step S832), and if the flag of the data is not a value 0, transmits a second error reply (step S851). This means that the data storage server informs the processing analysis server the of the error type. Referring to FIG. 26, when the processing analysis server receives an error reply, the processing analysis server determines the type, and if it is the first error reply (YES at step S841), the processing analysis server moves to the processing of step S808, while if it is the second error reply (NO at step S841), the processing analysis server transmits an error reply to the client and moves to the processing of step S801.

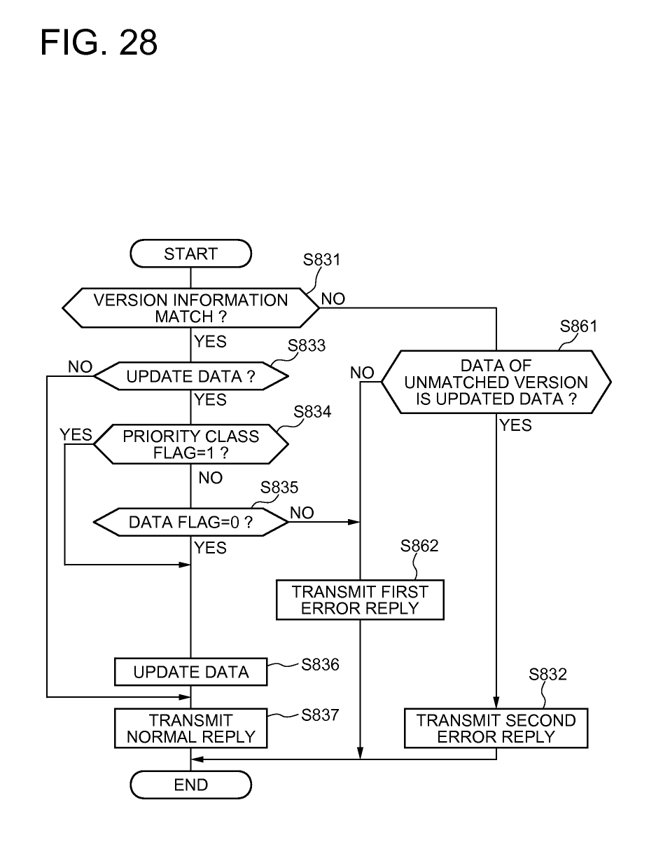

Further, if the present embodiment is based on the seventh exemplary embodiment, the processing analysis server performs processing of FIG. 26 instead of the processing of FIG. 23, and the data storage server performs processing of FIG. 28 instead of the processing of FIG. 24. Referring to FIG. 28, if the version information does not match, the data storage server determines whether or not the data, in which the version does not match, is updated data (step S861), and if it is not updated data, the data storage server transmits a first error reply to the processing analysis server (step S862), while if it is updated data, transmits a second error reply (step S851). When the processing analysis server receives an error reply, it determines the type thereof, and if the error reply is the first error reply (YES at step S841), the processing analysis server moves to the processing of step S808, while if it is the second error reply (NO at step S841), moves to the processing of step S801.

While the present invention has been described above with some exemplary embodiments, the present invention is not limited to the above-described exemplary embodiments, and other various additions and changes may be made therein.

### INDUSTRIAL APPLICABILITY

The present invention is advantageous to be used in a transaction processing system, and in particular, in a system which processes a long transaction.

The whole or part of the exemplary embodiments disclosed above can be described as, but not limited to, the following supplementary notes.

### (Supplementary Note 1)

A transaction processing system comprising:

a client device that transmits a transaction;

a data storage device that stores a set of data and a flag; and

a server device connected between the client device and the data storage device, wherein

the server device includes:
a priority determination unit that determines whether or not the transaction received from the client device belongs to a priority class;
a flag processing unit that sets a value of the flag of the same set as the data to be used in the transaction determined to belong to the priority class, among the data stored in the data storage device, to a value that restricts update by a transaction not belonging to the priority class; and
a transaction execution section that controls execution of the transaction received from the client device, based on optimistic exclusion.

### (Supplementary Note 2)

The transaction processing system according to supplementary note 1, wherein

the data storage device stores a term of validity of the flag.

### (Supplementary Note 3)

The transaction processing system according to supplementary note 2, wherein

the term of validity of the flag is determined based on a required time for executing the transaction belonging to the priority class.

### (Supplementary Note 4)

The transaction processing system according to supplementary note 3, wherein

the value itself of the flag represents the term of validity of the flag.

### (Supplementary Note 5)

The transaction processing system according to any of supplementary notes 1 to 4, wherein

in the determination, the priority determination unit of the server device determines whether or not the transaction belongs to the priority class based on at least one of the followings:

information showing that the transaction belongs to the priority class is added to the transaction received from the client device;

the number of errors of the transaction is not less than a threshold number of times;

the required time for executing the transaction is not less than a threshold time; and

the data to be used in the transaction matches data described in a priority list stored in the server device.

### (Supplementary Note 6)

The transaction processing system according to any of supplementary notes 1 to 5, wherein

the data includes version information of the data, and

regarding the transaction not belonging to the priority class, the transaction execution section of the server device updates the data and the version information to be updated by the transaction after confirming that the version information of the data to be used by the transaction is the same as version information at a time of starting execution of the transaction and that the value of the flag of the data to be updated by the transaction is a value which does not restrict update by the transaction not belonging to the priority class, and commits the transaction, and

regarding the transaction belonging to the priority class, the transaction execution section commits the transaction after confirming that the version information of the data to be used by the transaction is the same as the version information at the time of starting execution of the transaction.

### (Supplementary Note 7)

The transaction processing system according to supplementary note 6, wherein

in the commit, the transaction execution section of the server device reads version information of the data and the value of the flag from the data storage device to the server device, confirms that the version information of the data to be used by the transaction is the same as the version information at the time of starting execution of the transaction, and confirms that the value of the flag of the data to be updated by the transaction is a value which does not restrict update by the transaction not belonging to the priority class.

### (Supplementary Note 8)

The transaction processing system according to supplementary note 6, wherein

in the commit, the transaction execution section of the server device transmits a data reflection request to the data storage device, the data reflection request including information of whether or not the transaction which is a target of the commit belongs to the priority class, and identification information, version information, and data after update of the data referred to or updated by the transaction which is the target of the commit, and performs the commit based on a reply to the data reflection request from the data storage device,

the data storage device receives the data reflection request,

regarding the data reflection request according to the transaction not belonging to the priority class, the data storage device confirms that the version information of the data to be used by the transaction is the same as the version information at a time of starting execution of the transaction and that the value of the flag of the data to be updated by the transaction is a value which does not restrict update by the transaction not belonging to the priority class, and then updates the value of the data to be updated by the transaction to data after update and updates the version information, and transmits a reply to a processing analysis server, and

regarding the data reflection request according to the transaction belonging to the priority class, the data storage device confirms that the version information of the data to be used by the transaction is the same as the version information at the time of starting execution of the transaction, and then updates the value of the data to be updated by the transaction to data after update and updates the version information, and transmits a reply to the processing analysis server.

### (Supplementary Note 9)

The transaction processing system according to supplementary note 6, wherein

if the commit failed, the transaction execution section re-executes the transaction in which the commit failed, including processing to check whether or not the transaction belongs to the priority class.

### (Supplementary Note 10)

The transaction processing system according to supplementary note 6, wherein

if the transaction not belonging to the priority class failed the commit due to a restriction by the flag, the transaction execution section determines the transaction to be an error without performing re-execution.

### (Supplementary Note 11)

A transaction processing method performed by a transaction processing system including a client device, a data storage device that stores a set of data and a flag, and a server device connected between the client device and the data storage device, the method comprising:

by the client device, transmitting a transaction to the server device; and

by the server device, determining whether or not the transaction received from the client device belongs to a priority class, setting a value of the flag of the same set as the data to be used in the transaction determined to belong to the priority class, among the data stored in the data storage device, to a value that restricts update by a transaction not belonging to the priority class, and controlling execution of the transaction received from the client device, based on optimistic exclusion.

### (Supplementary Note 12)

A server device connected between a client device that transmits a transaction and a data storage device that stores a set of data and a flag, the device comprising:

a priority determination unit that determines whether or not the transaction received from the client device belongs to a priority class;

a flag processing unit that sets a value of the flag of the same set as the data to be used in the transaction determined to belong to the priority class, among the data stored in the data storage device, to a value that restricts update by a transaction not belonging to the priority class; and a transaction execution section that controls execution of the transaction received from the client device, based on optimistic exclusion.

### (Supplementary Note 13)

The server device according to supplementary note 9, wherein

the data storage device stores a term of validity of the flag.

### (Supplementary Note 14)

The server device according to supplementary note 10, wherein

the term of validity of the flag is determined based on a required time for executing the transaction belonging to the priority class.

### (Supplementary Note 15)

The server device according to supplementary note 11, wherein

the value itself of the flag represents the term of validity of the flag.

### (Supplementary Note 16)

The server device according to any of supplementary notes 12 to 15, wherein

in the determination, the priority determination unit determines whether or not the transaction belongs to the priority class based on at least one of the followings:

information showing that the transaction belongs to the priority class is added to the transaction received from the client device;

the number of errors of the transaction is not less than a threshold number of times;

the required time for executing the transaction is not less than a threshold time; and

the data to be used in the transaction matches data described in a priority list stored in the server device.

### (Supplementary Note 17)

The server device according to any of supplementary notes 12 to 16, wherein

the data includes version information of the data, and

regarding the transaction not belonging to the priority class, the transaction execution section updates the data and the version information to be updated by the transaction after confirming that the version information of the data to be used by the transaction is the same as version information at a time of starting execution of the transaction and that the value of the flag of the data to be updated by the transaction is a value which does not restrict update by the transaction not belonging to the priority class, and commits the transaction, and

regarding the transaction belonging to the priority class, the transaction execution section commits the transaction after confirming that the version information of the data to be used by the transaction is the same as the version information at the time of starting execution of the transaction.

### (Supplementary Note 18)

The server device according to supplementary note 14, wherein

in the commit, the transaction execution section reads version information of the data and the value of the flag from the data storage device to the server device, confirms that the version information of the data to be used by the transaction is the same as the version information at the time of starting execution of the transaction, and confirms that the value of the flag of the data to be updated by the transaction is a value which does not restrict update by the transaction not belonging to the priority class.

### (Supplementary Note 19)

The server device according to supplementary note 14, wherein

in the commit, the transaction execution section transmits a data reflection request to the data storage device, the data reflection request including information of whether or not the transaction which is a target of the commit belongs to the priority class, and identification information, version information, and data after update of the data referred to or updated by the transaction which is the target of the commit, and performs the commit based on a reply to the data reflection request from the data storage device,

the data storage device receives the data reflection request,

regarding the data reflection request according to the transaction not belonging to the priority class, the data storage device confirms that the version information of the data to be used by the transaction is the same as the version information at a time of starting execution of the transaction and that the value of the flag of the data to be updated by the transaction is a value which does not restrict update by the transaction not belonging to the priority class, and then updates the value of the data to be updated by the transaction to data after update and updates the version information, and transmits a reply to a processing analysis server, and

regarding the data reflection request according to the transaction belonging to the priority class, the data storage device confirms that the version information of the data to be used by the transaction is the same as the version information at the time of starting execution of the transaction, and then updates the value of the data to be updated by the transaction to data after update and updates the version information, and transmits a reply to the processing analysis server.

### (Supplementary Note 20)

The server device according to supplementary note 17, wherein

if the commit failed, the transaction execution section re-executes the transaction in which the commit failed, including processing to check whether or not the transaction belongs to the priority class.

### (Supplementary Note 21)

The server device according to supplementary note 17, wherein

if the transaction not belonging to the priority class failed the commit due to a restriction by the flag, the transaction execution section determines the transaction to be an error without performing re-execution.

### (Supplementary Note 22)

A transaction processing method performed by a server device connected between a client device that transmits a transaction and a data storage device that stores a set of data and a flag, the method comprising:

determining whether or not the transaction received from the client device belongs to a priority class;

setting a value of the flag of the same set as the data to be used in the transaction determined to belong to the priority class, among the data stored in the data storage device, to a value that restricts update by a transaction not belonging to the priority class; and

controlling execution of the transaction received from the client device, based on optimistic exclusion.

### (Supplementary Note 23)

A program for causing a computer to function as, the computer constituting a server device connected between a client device that transmits a transaction and a data storage device that stores a set of data and a flag:

a priority determination unit that determines whether or not the transaction received from the client device belongs to a priority class;

a flag processing unit that sets a value of the flag of the same set as the data to be used in the transaction determined to belong to the priority class, among the data stored in the data storage device, to a value that restricts update by a transaction not belonging to the priority class; and

a transaction execution section that controls execution of the transaction received from the client device, based on optimistic exclusion.

1. A transaction processing system comprising:
a client device that transmits a transaction;
a data storage device that stores a set of data and a flag; and
a server device connected between the client device and the data storage device, wherein
the server device includes:
a priority determination unit that determines whether or not the transaction received from the client device belongs to a priority class;
a flag processing unit that sets a value of the flag of the same set as the data to be used in the transaction determined to belong to the priority class, among the data stored in the data storage device, to a value that restricts update by a transaction not belonging to the priority class; and
a transaction execution section that controls execution of the transaction received from the client device, based on optimistic exclusion.

2. The transaction processing system according to claim 1, wherein
the data storage device stores a term of validity of the flag.

3. The transaction processing system according to claim 2, wherein
the term of validity of the flag is determined based on a required time for executing the transaction belonging to the priority class.

4. The transaction processing system according to claim 3, wherein
the value itself of the flag represents the term of validity of the flag.

5. The transaction processing system according to claim 1, wherein
in the determination, the priority determination unit of the server device determines whether or not the transaction belongs to the priority class based on at least one of the followings:
information showing that the transaction belongs to the priority class is added to the transaction received from the client device;
the number of errors of the transaction is not less than a threshold number of times;
the required time for executing the transaction is not less than a threshold time; and
the data to be used in the transaction matches data described in a priority list stored in the server device.

6. The transaction processing system according to claim 1, wherein
the data includes version information of the data, and
regarding the transaction not belonging to the priority class, the transaction execution section of the server device updates the data and the version information to be updated by the transaction after confirming that the version information of the data to be used by the transaction is the same as version information at a time of starting execution of the transaction and that the value of the flag of the data to be updated by the transaction is a value which does not restrict update by the transaction not belonging to the priority class, and commits the transaction, and
regarding the transaction belonging to the priority class, the transaction execution section commits the transaction after confirming that the version information of the data to be used by the transaction is the same as the version information at the time of starting execution of the transaction.

7. The transaction processing system according to claim 6, wherein
in the commit, the transaction execution section of the server device reads version information of the data and the value of the flag from the data storage device to the server device, confirms that the version information of the data to be used by the transaction is the same as the version information at the time of starting execution of the transaction, and confirms that the value of the flag of the data to be updated by the transaction is a value which does not restrict update by the transaction not belonging to the priority class.

8. The transaction processing system according to claim 6, wherein
in the commit, the transaction execution section of the server device transmits a data reflection request to the data storage device, the data reflection request including information of whether or not the transaction which is a target of the commit belongs to the priority class, and identification information, version information, and data after update of the data referred to or updated by the transaction which is the target of the commit, and performs the commit based on a reply to the data reflection request from the data storage device,
the data storage device receives the data reflection request,
regarding the data reflection request according to the transaction not belonging to the priority class, the data storage device confirms that the version information of the data to be used by the transaction is the same as the version information at a time of starting execution of the transaction and that the value of the flag of the data to be updated by the transaction is a value which does not restrict update by the transaction not belonging to the priority class, and then updates the value of the data to be updated by the transaction to data after update and updates the version information, and transmits a reply to a processing analysis server, and
regarding the data reflection request according to the transaction belonging to the priority class, the data storage device confirms that the version information of the data to be used by the transaction is the same as the version information at the time of starting execution of the transaction, and then updates the value of the data to be updated by the transaction to data after update and updates the version information, and transmits a reply to the processing analysis server.

9. A server device connected between a client device that transmits a transaction and a data storage device that stores a set of data and a flag, the device comprising:
a priority determination unit that determines whether or not the transaction received from the client device belongs to a priority class;
a flag processing unit that sets a value of the flag of the same set as the data to be used in the transaction determined to belong to the priority class, among the data stored in the data storage device, to a value that restricts update by a transaction not belonging to the priority class; and
a transaction execution section that controls execution of the transaction received from the client device, based on optimistic exclusion.

10. The server device according to claim 9, wherein
the data storage device stores a term of validity of the flag.

11. The server device according to claim 10, wherein
the term of validity of the flag is determined based on a required time for executing the transaction belonging to the priority class.

12. The server device according to claim 11, wherein
the value itself of the flag represents the term of validity of the flag.

13. The server device according to claim 9, wherein
in the determination, the priority determination unit determines whether or not the transaction belongs to the priority class based on at least one of the followings:
information showing that the transaction belongs to the priority class is added to the transaction received from the client device;
the number of errors of the transaction is not less than a threshold number of times;
the required time for executing the transaction is not less than a threshold time; and
the data to be used in the transaction matches data described in a priority list stored in the server device.

14. The server device according to claim 9, wherein
the data includes version information of the data, and
regarding the transaction not belonging to the priority class, the transaction execution section updates the data and the version information to be updated by the transaction after confirming that the version information of the data to be used by the transaction is the same as version information at a time of starting execution of the transaction and that the value of the flag of the data to be updated by the transaction is a value which does not restrict update by the transaction not belonging to the priority class, and commits the transaction, and
regarding the transaction belonging to the priority class, the transaction execution section commits the transaction after confirming that the version information of the data to be used by the transaction is the same as the version information at the time of starting execution of the transaction.

15. The server device according to claim 14, wherein
in the commit, the transaction execution section reads version information of the data and the value of the flag from the data storage device to the server device, confirms that the version information of the data to be used by the transaction is the same as the version information at the time of starting execution of the transaction, and confirms that the value of the flag of the data to be updated by the transaction is a value which does not restrict update by the transaction not belonging to the priority class.

16. The server device according to claim 14, wherein
in the commit, the transaction execution section transmits a data reflection request to the data storage device, the data reflection request including information of whether or not the transaction which is a target of the commit belongs to the priority class, and identification information, version information, and data after update of the data referred to or updated by the transaction which is the target of the commit, and performs the commit based on a reply to the data reflection request from the data storage device,
the data storage device receives the data reflection request,
regarding the data reflection request according to the transaction not belonging to the priority class, the data storage device confirms that the version information of the data to be used by the transaction is the same as the version information at a time of starting execution of the transaction and that the value of the flag of the data to be updated by the transaction is a value which does not restrict update by the transaction not belonging to the priority class, and then updates the value of the data to be updated by the transaction to data after update and updates the version information, and transmits a reply to a processing analysis server, and
regarding the data reflection request according to the transaction belonging to the priority class, the data storage device confirms that the version information of the data to be used by the transaction is the same as the version information at the time of starting execution of the transaction, and then updates the value of the data to be updated by the transaction to data after update and updates the version information, and transmits a reply to the processing analysis server.

17. A transaction processing method performed by a server device connected between a client device that transmits a transaction and a data storage device that stores a set of data and a flag, the method comprising:
determining whether or not the transaction received from the client device belongs to a priority class;
setting a value of the flag of the same set as the data to be used in the transaction determined to belong to the priority class, among the data stored in the data storage device, to a value that restricts update by a transaction not belonging to the priority class; and
controlling execution of the transaction received from the client device, based on optimistic exclusion.
